(19) United States
(12) Patent Application Publication
(10) Pub. No.: US 2006/0282291 A1
(43) Pub. Date: Dec. 14, 2006

(54) Method and means for analysis of incident data

(75) Inventor: William Runciman, Adelaide (AU)

Correspondence Address: AKERMAN SENTERFITT, P.O. BOX 3188, WEST PALM BEACH, FL, 33402-3188, US

(73) Assignee: The Australian Patient Safety Foundation Incorporated, Adelaide (AU)

(21) Appl. No.: 11/103,102

(22) Filed: Apr. 11, 2005

(51) Int. Cl. G06F 19/00

(52) U.S. Cl. 705/3

(57) ABSTRACT

A method and a computer system for implementing the method for the analysis of avoidable potentially harmful incident data employing a hierarchical series of response requests in the form of a question to be answered, and one or more generic response identifiers selected from a data base of a plurality of generic response identifiers, using the one or more selected generic response identifier or identifiers to effect a selection from a data base of a further response request question which will be hierarchical to the first said response.

### TECHNICAL FIELD

This invention relates to a method for assisting analysis of avoidable potentially harmful incident data, a computer program for this purpose and a computer programmed for this purpose.

### BACKGROUND ART

It is a significant problem that there are incidents in many disciplines which cause harm.

A typical and tragic example is the health industry in Australia where it is estimated that there may at the present time be some 18000 deaths alone apart from injuries per year caused by incidents that could be avoidable. The problem is clearly huge in this industry and it is realized that other disciplines or industries will be suffering similarly.

It is also considered that there are a number of reasons why such incidents are difficult to firstly detect and even when detected to analyse so that something usefully can be done by those anxious to reduce these statistics. By their fundamental character these incidents are not deliberate but may be classed as negligent and may incur liability if discovered and allocated to a person or institution. Further however there are difficulties in being able to identify common causes which may be able then to be dealt with by a solution that will have more than a one off effect in reducing this problem.

An object of this invention is to reduce at least to some extent one or more of these problems.

### DISCLOSURE OF THE INVENTION

In one form of the invention, there is provided a method for assisting analysis of avoidable potentially harmful incident data which includes collecting and classifying incidents, the method including displaying a first of a hierarchical series of response requests in the form of a question to be answered,
selecting for each said first response request one or more generic response identifiers selected from a data base of a plurality of generic response identifiers,
then using the one or more selected generic response identifier or identifiers to effect a selection from a data base of a further response request question which will be hierarchical to the first said response and
then displaying a selected further response request question which is chosen to be relevant to the or each selected generic response identifier,
and storing information sufficient to identify the hierarchy of response request and response identifier or identifiers.

In a further form the invention could be said to reside in a computer programmed so that it will effect a method for assisting analysis of avoidable potentially harmful incident data which includes collecting and classifying incidents, the method including displaying as a visual output a first of a hierarchically arranged series of response requests in the form of a question to be answered,
the computer then effecting a selection for each said first response request answer of a one or more classifying identifier selected from a data base of a plurality of generic response identifiers, then using the one or more selected generic response identifier or identifiers to effect a selection from a data base of a further question which will be follow the context of to the first said response and then displaying a selected further response request question which is chosen to be relevant to the or each selected generic response identifier,
and storing information sufficient to identify the hierarchy or series in ranking of a response request and response identifier or identifiers.

In preference, there may be more than one hierarchical series of response requests related to a single incident.

In preference a combination of the response requests and the corresponding response identifiers in a single hierarchical series can be said to be a classification structure.

In preference, the response requests are those specified by a hierarchical incident model selected for a specific industry or incident type.

In preference, the incident data to be collected is health care incident data.

In preference, the hierarchical incident model is the Runciman model.

In a further form of the invention, it may be said to reside in a computer system arranged to
display a first of a hierarchical series of response requests, then
effect a selection of one or more of a plurality of generic response identifiers from a data base in response to said request,
said selection effecting the display of a selected further response request, relevant to the selected generic response identifier,
then to store information sufficient to identify the hierarchy of response request and response identifier,
and repeating these steps to elicit further information about an incident.

In preference, the computer system is adapted to display data entry forms and resulting classifications together to facilitate the building of incident reporting and classification structures.

In preference, selected cascading branches of a classification structure are reused as required in other classification structures.

In preference, each classification structure includes a selected number of primary classification categories.

These classification categories may include “Who/Where/What/When/Why/How”, “Details”, Contributing Factors”; “Prevention”, and Outcomes”.

In preference, the computer system is adapted to accept centralised control and modification of the classification hierarchy.

In preference, the text displayed to enable the selection of a generic response identifier is in a user selectable language.

In preference, text displayed to enable a selection of a generic response identifier is a user selectable description standard.

It will now be understood that by changing any input response to a generic identifier this then allows for a huge amount of variation in reporting languages, styles, and disciplines to be accepted in the responses but still allow for effective and efficient analysis subsequently. For instance if a person in one area uses the word broken skin, another abrasion or another the French word for this with local variations it will be understood how it becomes in a large analysis very difficult indeed to apply some logical and efficient detection strategy for common incidents. By firstly reducing these to a common generic identifier then having the questions in any series under a single hierarchy selected and only following in a logical progression based upon the immediately preceding response allows for this major improvement.

A size of a hierarchical classification structure for instance in the health industry that is both comprehensive, that covers all required possibilities, and detailed, in that it includes all detail required for in-depth analyses, is necessarily very large.

In the Runciman model for healthcare incident classification there are hundreds of thousands of branches in the classification tree. The computer system is adapted to enable the very large hierarchical classification structure to be maintained and presented to users in an efficient and practical way. In particular, users entering and viewing incident classification data can do so without seeing any irrelevant parts of the very large hierarchical classification structure. This has the advantage of reducing the time spent on incident reporting. Time spent by staff in entering incident classifications is significant and classification tasks may be bypassed if human resources to do so are insufficient.

In preference rules are used to provide users with context-sensitive help and correct usage instructions. The rules are entered into the database at the time the hierarchy items are entered and these may be further tailored at any subsequent time by user-oriented non-IT staff. The integrated and dynamic nature of this design has the advantage of facilitating accurate data capture.

The use of the same hierarchical structure for the definition of data entry forms as for the classification structure has the very significant advantage of improving consistency of programs, data and usage. Data entry form design can be performed without any computer program changes and by staff having no computer programming expertise.

A hierarchical classification structure for the health industry has been developed after a great amount of research and experience in the field of health incident classification. Whilst some parts of the classification contain sub-classifications that are standard in the health industry, e.g. medications, the content of the classification as a whole is innovative and costly to develop and has therefore been kept proprietary.

### BRIEF DESCRIPTION OF THE DRAWINGS

For a better understanding of the invention an embodiment will be described with the assistance of drawings wherein:

FIG. 1 is a block diagram illustrating the overall context of the preferred embodiment of the invention and its associated components.

FIG. 2 is an illustration of the context of the invention in relation to the enhancement of the classification structures, which is core to this invention, through external organizations analysis, research and policy investigations and feed back/recommendation.

FIG. 3 is an illustration of the modular structure of the computer programs which host the functionality of this invention.

FIG. 4 is a diagram illustrating the generic reference model (Runciman Model), which is used in this embodiment of the invention as a framework for structuring the classification hierarchy.

FIG. 5 is a high level representation of the database structure used in this embodiment of the invention.

FIG. 6 is an exemplary illustration showing the first (highest) level of the classification hierarchy.

FIG. 7 is an exemplary illustration showing the standardised categories level of the classification hierarchy which ties in with the principles of the Runciman Model as shown in FIG. 4.

FIG. 8 is an exemplary illustration showing the level of the classification hierarchy known as “Main Questions” in this embodiment of the invention.

FIG. 9 is an exemplary illustration showing lower levels of a classification hierarchy represented within this embodiment of the invention.

FIG. 10 is an exemplary illustration of the reuse of “Terms” in different branches and nodes in classification hierarchy represented within this embodiment of the invention.

FIG. 11 is an exemplary illustration of the main functionality buttons of the hierarchical structure generation and management module in the preferred embodiment of the invention.

FIG. 12 is an exemplary illustration of the login credentials user input screen generated by the hierarchical structure generation and management module in an embodiment of the invention.

FIG. 13 is an exemplary screen showing the hierarchical structure generation and management module's visual representation of the hierarchical structure generated by an embodiment of the invention.

FIG. 14 is an exemplary screen showing the hierarchical structure generation and management module's visual representation of the “Terms” list generated by an embodiment of the invention.

FIG. 15 is an exemplary screen showing the hierarchical structure generation and management module's visual representation of the hierarchical structure generated by an embodiment of the invention.

FIG. 16 is an exemplary illustration of the hierarchical structure generation and management module screen showing the high level hierarchical branches which host definitions of data entry fields generated by an embodiment of the invention.

FIG. 17 is an exemplary illustration of an expansion of the high level hierarchical branches hosting the data entry field definitions, showing the lower level branches, nodes and leaves generated by an embodiment of the invention.

FIG. 18 is an exemplary illustration of an expansion of the high level hierarchical branches hosting the assembly components, showing the lower level branches, nodes and leaves generated by an embodiment of the invention.

FIG. 19 is an exemplary illustration of an expansion of the high level hierarchical branches hosting the incident reports elements, showing the immediate lower level branches, generated by an embodiment of the invention.

FIG. 20 is an exemplary illustration of an expansion of the hierarchical branches relating to patient incidents data entry form, showing the immediate lower level branches, and showing the use of the New button for the creation of a new data entry field, generated by an embodiment of the invention.

FIG. 21 is an exemplary illustration showing the further expansion of the hierarchical branches relating to patient incidents data entry form, showing the lower level branches, nodes and leaves, generated by an embodiment of the invention.

FIG. 22 is an exemplary illustration showing the start point for the creation of new data entry forms within a branch of hierarchical tree, generated by an embodiment of the invention.

FIG. 23 is an exemplary illustration showing the available terms list for inclusion in data entry forms as part of the creation of new items on a data entry form, generated by an embodiment of the invention.

FIG. 24 is an exemplary illustration showing the addition of a collection of data entry fields to a branch within a data entry form, generated by an embodiment of the invention.

FIG. 25 is an exemplary illustration showing the newly added data entry fields in position within a data entry form, as generated by an embodiment of the invention.

FIG. 26 is an exemplary illustration showing the risk register branch and components of the data entry hierarchy as generated by an embodiment of the invention.

FIG. 27 is an exemplary illustration of the classification branch of the hierarchical structure, indicating a particular classification (HIT) “Falls” in context, as generated by the preferred embodiment of the invention.

FIG. 28 is an exemplary illustration of the primary classification categories within a classification (HIT) as generated by a preferred embodiment of the invention.

FIG. 29 is an exemplary illustration of the main questions existent at the immediate hierarchical level below primary classification categories, as generated by a preferred embodiment of the invention.

FIG. 30 is an exemplary illustration of the classification questions existent at the immediate hierarchical level below main questions, as generated by a preferred embodiment of the invention.

FIG. 31 is an exemplary illustration of the low level questions existent at the leaf level of the classification hierarchy, as generated by a preferred embodiment of the invention.

FIG. 32 is an exemplary illustration of the starting point for the creation of a new classification question within a branch of the hierarchy at the level below main questions, as generated by an embodiment of the invention.

FIG. 33 is an exemplary illustration of the list of available classification questions, which may be used when creating new questions in the hierarchy, as generated by an embodiment of the invention.

FIG. 34 is an exemplary illustration of the principal function buttons within the Data Manager module, as generated by an embodiment of the invention.

FIG. 35 is an exemplary illustration of the main incident management screen as generated by an embodiment of the invention.

FIG. 36 is an exemplary illustration of the incident view selection screen as generated by an embodiment of the invention.

FIG. 37 is an exemplary illustration of the summary incident statistics screen as generated by an embodiment of the invention.

FIG. 38 is an exemplary illustration of the incident linking functions present in the Data Manager module, as generated by an embodiment of the invention.

FIG. 39 is an exemplary illustration of a starting point for creation of a new incident using an incident data entry form of type patient incident, as generated by an embodiment of the invention.

FIG. 40 is an exemplary illustration of the data entry form for risk register, generated by an embodiment of the invention.

FIG. 41 is an exemplary illustration of the main data entry and classification screen within the Data Manager module, as generated by an embodiment of the invention.

FIG. 42 is an exemplary illustration of the main data entry and classification screen within the Data Manager module, showing some of the classification questions being complete, as generated by an embodiment of the invention.

FIG. 43 is an exemplary illustration of the main data entry and classification screen within the Data Manager module, showing some incident types selected for the incident, as generated by an embodiment of the invention.

FIG. 44 is an exemplary illustration of the main data entry and classification screen within the Data Manager module, showing additional sections of the classification hierarchy as completed, as generated by an embodiment of the invention.

FIG. 45 is an exemplary illustration of the incident type selection screen as generated by an embodiment of the invention.

FIG. 46 is an exemplary illustration of the Severity Assessment Code selection screen as generated by an embodiment of the invention.

FIG. 47 is an exemplary illustration of the data entry form rules message screen as generated by an embodiment of the invention.

FIG. 48 is an exemplary illustration of an expansion of the classification hierarchy questions to the lowest level of detail, as generated by an embodiment of the invention.

FIG. 49 is an exemplary illustration of the close incident screen, as generated by an embodiment of the invention.

FIG. 50 is an exemplary illustration of the project tasks screen as generated by an embodiment of the invention.

FIG. 51 is an exemplary illustration of the notifications selection screen as generated by an embodiment of the invention.

FIG. 52 is an exemplary illustration of the run incident reports selection screen as generated by an embodiment of the invention.

FIG. 53 is an exemplary illustration of the initial part of an incident details report, produced by the Data Manager module after selection of an incident, as generated by an embodiment of the invention.

FIG. 54 is an exemplary illustration of the design incident report screen within the Data Manager module showing the basic attributes of a particular report, as generated by an embodiment of the invention.

FIG. 55 is an exemplary illustration of the main functional buttons within the Analyser module, as generated by an embodiment of the invention.

FIG. 56 is an exemplary illustration of the user options, view selection screen within the Analyser module, as generated by an embodiment of the invention.

FIG. 57 is an exemplary illustration of the run reports selection screen showing a report highlighted and the run properties of the particular report as generated by an embodiment of the invention.

FIG. 58 is an exemplary illustration of the run report groups selection screen showing a group highlighted and the reports belonging to the group as generated by an embodiment of the invention.

FIG. 59 is an exemplary illustration of the run report batches selection screen showing a batch highlighted and the groups belonging to the batch as generated by an embodiment of the invention.

FIG. 60 is an exemplary illustration of the run report preview screen showing a chart as generated by an embodiment of the invention.

FIG. 61 is an exemplary illustration of the run report preview screen showing chart data as generated by an embodiment of the invention.

FIG. 62 is an exemplary illustration of the run report preview screen showing a multi-column report as generated by an embodiment of the invention.

FIG. 63 is an exemplary illustration of the run report preview screen showing a risk matrix as generated by an embodiment of the invention.

FIG. 64 is an exemplary illustration of the run report preview screen showing a user-configurable chart as generated by an embodiment of the invention.

FIG. 65 is an exemplary illustration of the main report design screen showing a list of report designs with a report highlighted and the details of the highlighted report design as generated by an embodiment of the invention.

FIG. 66 is an exemplary illustration of the query design screen showing a list of queries with a query highlighted and the details of the highlighted query as generated by an embodiment of the invention.

FIG. 67 is an exemplary illustration of the query design builder screen showing a list of available terms and classifications available and the details of a partially built query as generated by an embodiment of the invention.

FIG. 68 is an exemplary illustration of the new or edit chart report design screen showing a list of report designs with one report design highlighted and the details of the highlighted report design and the chart report wizard button as generated by an embodiment of the invention.

FIG. 69 is an exemplary illustration of the new or edit non-chart report design screen showing a list of report designs with one report design highlighted and the details of the highlighted report design as generated by an embodiment of the invention.

FIG. 70 is an exemplary illustration of the first screen in the Workflow module, showing the principal function buttons, as generated by an embodiment of the invention.

FIG. 71 is an exemplary illustration of the maintain workflow designs screen, as generated by an embodiment of the invention.

FIG. 72 is an exemplary illustration of the workflow design editing screen showing the General properties tab, as generated by an embodiment of the invention.

FIG. 73 is an exemplary illustration of the workflow design editing screen showing the Tasks definition tab displaying a simple workflow structure, as generated by an embodiment of the invention.

FIG. 74 an exemplary illustration of the workflow project editing screen showing the General properties tab with project details entered, as generated by an embodiment of the invention.

FIG. 75 is an exemplary illustration of the workflow project editing screen showing the Tasks definition tab displaying a simple workflow structure and task assignment details completed, as generated by an embodiment of the invention.

FIG. 76 is an exemplary illustration of the Data Manager task review screen showing the projects and tasks requiring attention by a user, and basic project details of the due task, as generated by an embodiment of the invention.

FIG. 77 is an exemplary illustration of the Data Manager task review screen showing the projects and tasks requiring attention by a user, and project task details, as generated by an embodiment of the invention.

FIG. 78 is an exemplary illustration of the Data Manager task review screen showing the projects and tasks requiring attention by a user, and task dependencies, as generated by an embodiment of the invention.

FIG. 79 is an exemplary illustration of the definition of a trigger data field for the workflow, showing the trip, slip or stumble selection, as generated by an embodiment of the invention.

FIG. 80 is an exemplary illustration of the results of selecting a trigger data field for the workflow, as generated by an embodiment of the invention.

FIG. 81 is an exemplary illustration of the first screen of the Administrator module, showing the principal function buttons, as generated by an embodiment of the invention.

FIG. 82 is an exemplary illustration of the organization definition page within the Administrator module, as generated by an embodiment of the invention.

FIG. 83 is an exemplary illustration of the groups definition page within the Administrator module, showing the general details entry tab, as generated by an embodiment of the invention.

FIG. 84 is an exemplary illustration of the groups definition page within the Administrator module, showing the applications detail entry tab, as generated by an embodiment of the invention.

FIG. 85 is an exemplary illustration of the user definition page within the Administrator module, showing user attributes, as generated by an embodiment of the invention.

FIG. 86 is an exemplary illustration of the Permissions definition page within the Administrator module, showing the permissions for user, group and organization combinations, as generated by an embodiment of the invention.

FIG. 87 is a is an exemplary illustration of the data administration options within the Administrator module, as generated by an embodiment of the invention.

FIG. 88 is an exemplary illustration of the targeting definition page within the Administrator module, showing the selection of a targeted data item, the linkage to an organisational hierarchy, as generated by an embodiment of the invention.

FIG. 89 is an exemplary illustration of the auditing functions of the Administrator module, showing audit report selection criteria and a sample report output, as generated by an embodiment of the invention.

FIG. 90 is an exemplary illustration of the system registration key function of the Administrator module, as generated by an embodiment of the invention.

FIG. 91 is an exemplary illustration of the first screen of the Database Administrator module, showing the principal function buttons, as generated by an embodiment of the invention.

FIG. 92 is an exemplary illustration of the main database administration screen, showing details of the scripts/update history and the details of individual scripts/updates applied, as generated by an embodiment of the invention.

FIG. 93 is an exemplary illustration of the import functionality screen, showing the import mapping definition, the import target organization and the mapped fields, as generated by an embodiment of the invention.

FIG. 94 is an exemplary illustration of the Web-Form module incident management web page, showing a list of recorded incidents and their basic attributes, as generated by an embodiment of the invention.

FIG. 95 is an exemplary illustration of the Web-Form module's data entry web page, showing incident recording data entry fields, as generated by an embodiment of the invention.

FIG. 96 is an exemplary illustration of the Agent module main screen, showing agent configuration properties and agent processing history details, as generated by an embodiment of the invention.

FIG. 97 is an exemplary illustration of the Export module process method, showing the data item to file mapping procedure, as implemented in the preferred embodiment of the invention.

FIG. 98 is an exemplary illustration of a Root Cause analysis tree, showing in abstract result of a root cause analysis as conducted by the Root Cause module of the system, as generated by an embodiment of the invention.

### BEST MODE FOR CARRYING OUT THE INVENTION

For the purposes of promoting an understanding of the principles of the invention, reference will now be made to the embodiments illustrated in the drawings and specific language will be used to describe the same. It will nevertheless be understood that no limitation of the scope of the invention is hereby intended. Any alterations and further modifications in the described embodiments, and any further applications of the principles of the invention described herein are contemplated as would normally occur to one skilled in the art to which the invention relates. One embodiment is shown in detail for the purposes of the describing the invention, although it will be apparent to those skilled in the art that some of the features which are not relevant to the invention may not be shown for the sake of clarity.

A number of exemplary screens/forms will be used in order to explain the present invention. It should be noted that the present invention is not intended to be limited to only the screens/forms shown in the drawings. As should be understood, screen/form designs containing additional and/or alternate combinations different from the ones herein described can also be used.

Shown in FIG. 1 is a preferred embodiment of a computer-implemented system for the recording and classification of healthcare related incidents. A brief overview of the system will be presented firstly, followed by a more detailed description of one embodiment of the system illustrated with a number of exemplary Figures and descriptions.

With reference to FIG. 1 the computer implemented system for the recording and classification of healthcare related incidents is, in this embodiment, known as the System illustrated at 1. The System comprises a series of computer-implemented software programs which together provide the functionality identified in these descriptions. The System stores incident and classification data in a database, known as the Database according to this embodiment and illustrated at 2. The software programs interact with the Database according to this embodiment in the performance of their functions. The System and the Database according to this embodiment are implemented on a computer, as illustrated at 3. In this embodiment of the invention, as shown in the exemplary illustrations that follow, the system is implemented in a Microsoft Windows™ operating environment (Microsoft Corporation, Redmond, Wash., USA) and the database in Microsoft SQL Server™. It may be readily contemplated that the system could be implemented in other operating and database environments by anyone skilled in the art.

With continued reference to FIG. 1 the System can be implemented in a local hospital, a group of hospitals, a region or state, or indeed at a national level or international level. Various combinations of the System configuration support these different scenarios. As an illustration a hospital 6 may install the System 1 and Database according to this embodiment 2 locally, and through the hospital's own network 10 and computers 11, record and classify incident information. In another embodiment a “Region” 8 may implement the System and Database according to this embodiment and grant access to it to hospitals 6, 7 in the Region through a network 5 (which can include the Internet, one or more Wide Area Networks (WAN), a Local Area Network (LAN), a proprietary network, a combination of these, or other network generally known by those skilled in the art). “PC” devices 4 can collect and classify incident information in the regional implementation, and such devices may in fact reside within hospitals or other organization where incident information is required to be gathered. In this configuration the regional implementation may also receive data from a local implementation of the System and Database. It may be readily contemplated that a national implementation 9 may be similarly flexibly configured. In the exemplary illustrations throughout this document a simple installation at a hospital 6 is considered.

The System and Database according to this embodiment were designed for the purpose of recording and classifying healthcare incident information. The principal purpose behind the recording and classification of such items is to generally improve healthcare procedures and practices to reduce the number of adverse incidents. Clearly there is both a local and national dimension to this, as hospitals seek to reduce their local incidence through local practice changes, and governments seek to reduce it on a national scale. One of the recognized aspects of incident recording and classification is the fact that some incidents are rare locally. Aggregating data on a national basis can show greater statistical significance, which of course enables the identification of procedure and practice change needs that may otherwise have been missed.

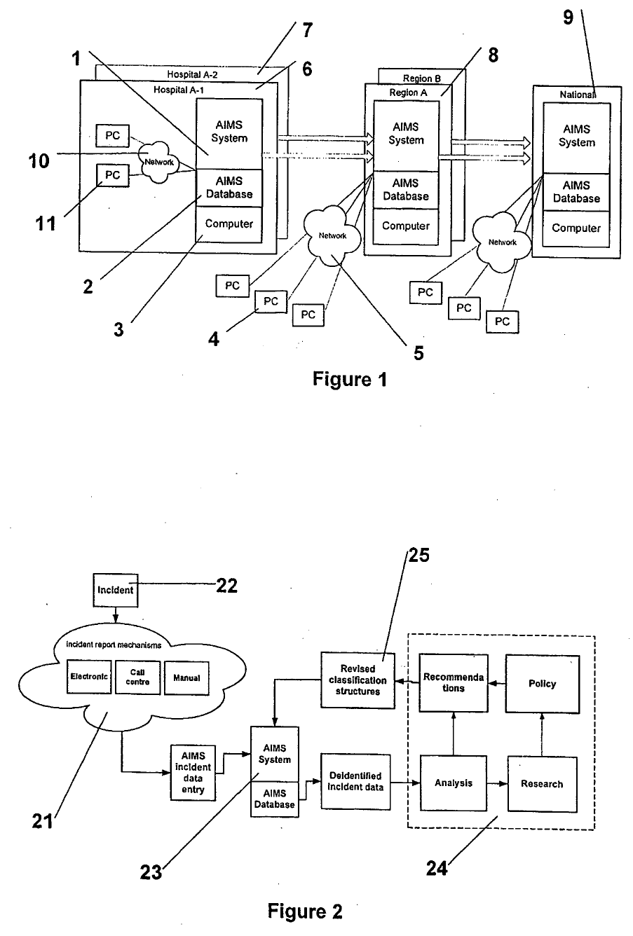

FIG. 2 illustrates the broad process by which incident information is aggregated and interpreted 24 and then fed back into the development of revised classifications for use in the System 23. Incidents identified at 22 may be reported via a number of mechanisms 21 which may be a range of electronic or other means. The incident data is collected through the System and de-identified (i.e. identification of individuals is removed to be anonymous) data passed to the body 24 which may be an internal organizational body, or other third party including, but not limited to, regional patient safety agencies, national/governmental agencies or international bodies. The outcome from the body 24 may be diverse, such as national policy guidance, incident statistics, clinical practice guidance, to name a few. However the element relevant to this embodiment of the invention is the recommended enhancements to the classification structures 25 which are then embodied within the System enabling improved incident recording and classification. The System supports this iterative classification enhancement approach through two principal mechanisms: a.) the ability to extract data for aggregation purposes, b.) the ability to incorporate enhancements to the classification system. These are explained in detail in the system functional descriptions that follow.

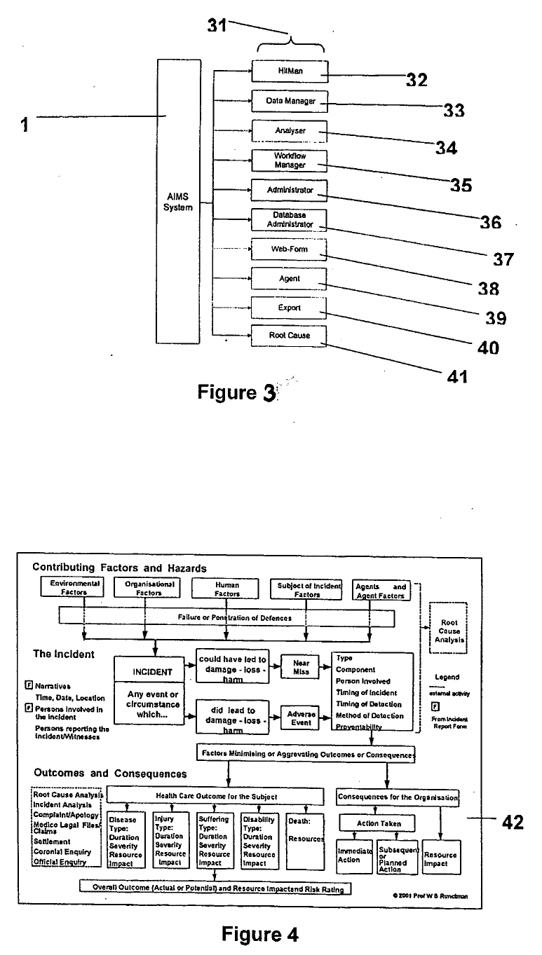

As stated earlier, the System 1 comprises a series of computer implemented software programs which together provide the functionality identified in these descriptions. The System 1 stores incident and classification data in a database, known as the Database according to this embodiment 2. The software programs interact with the Database according to this embodiment 2 in the performance of their functions. The functions within the System 1 are, in this embodiment of the invention, divided into separate functional modules which all act upon the Database according to this embodiment 2, however it may be readily contemplated by anyone skilled in the art that this functionality could be incorporated differently in other embodiments. FIG. 3 illustrates the main module structure 31 of the System 1, and identifies the principal functions (illustrated at 32) supported by the modules and identified within these detailed embodiment descriptions. In this embodiment of the invention, the modules are the hierarchical structure generation and management module 32, Data Manager 33, Analyser 34, Workflow Manager 35, Administrator 36, Database administrator 37, Web Form 38, Agent 39, Export 40 and Root Cause 41.

The System has been designed to facilitate incident data collection and classification, the basis for which is the generic reference model illustrated at FIG. 4 and known in this embodiment as the Runciman Model 42. This model sets out the basic components that are deemed necessary to adequately identify and classify healthcare incidents. The System implements this generic reference model in the form of an extensible hierarchical structure representing both incident data collection and incident classification taxonomies. As is apparent from the detailed descriptions of the preferred embodiment, these taxonomies are a fundamental component of the System functionalities and behaviours.

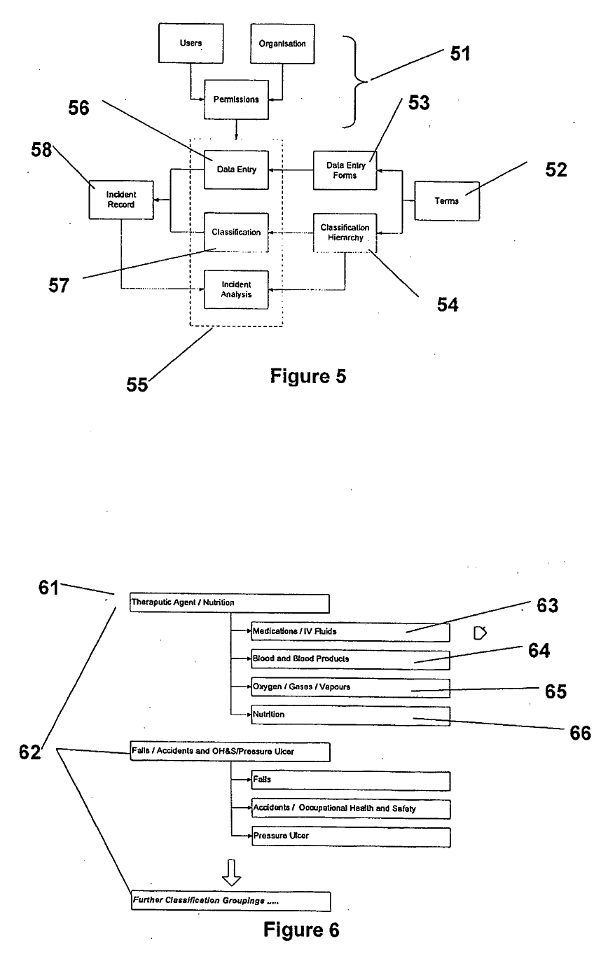

The System 1 stores incident and classification data in a database 2. A core part of this database is the representation of an extensible hierarchical structure that underpins this invention. FIG. 5 is a high level diagram of one exemplary illustration of a database structure, which has been used in this embodiment of the invention to store the taxonomies, incident data and classification data in a secure environment. The taxonomies are stored in a series of entities including but not limited to generic response identifiers called “Terms” 52, generic response request groupings called “Forms” 53 and a “Classification Hierarchy” 54. These entities are used by the Data Entry 56 and Classification 57 entities to structure capture of incident information via data entry forms, and classifications information via classification questions. The results of these actions are stored in the Incident Record 58. Incident records 58 are utilized in Incident Analysis 55 . Data Entry 56, Classification 57 and Incident Analysis 55, are all secured through a permissions structure illustrated at 51 which links in users, organizations and permissions into each entity 56, 57, 55.

It can be readily contemplated by anyone skilled in the art that the arrangement of entities within this high level diagram is one embodiment of the invention, and that other embodiments could be conceived by anyone skilled in the art.

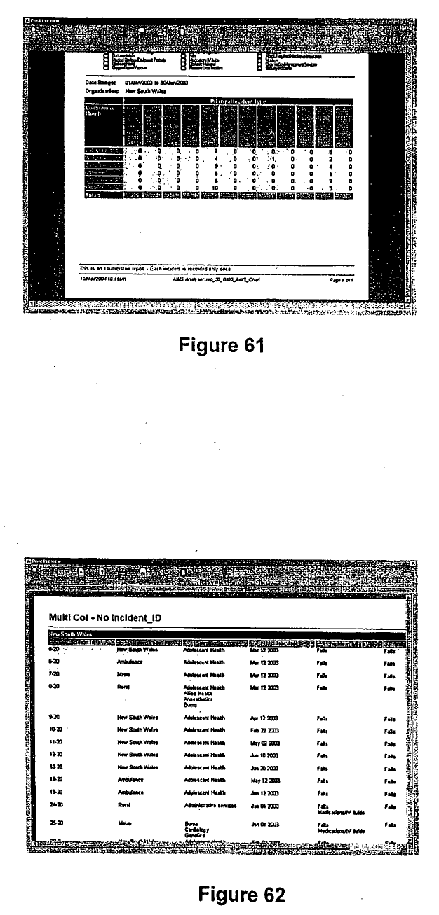

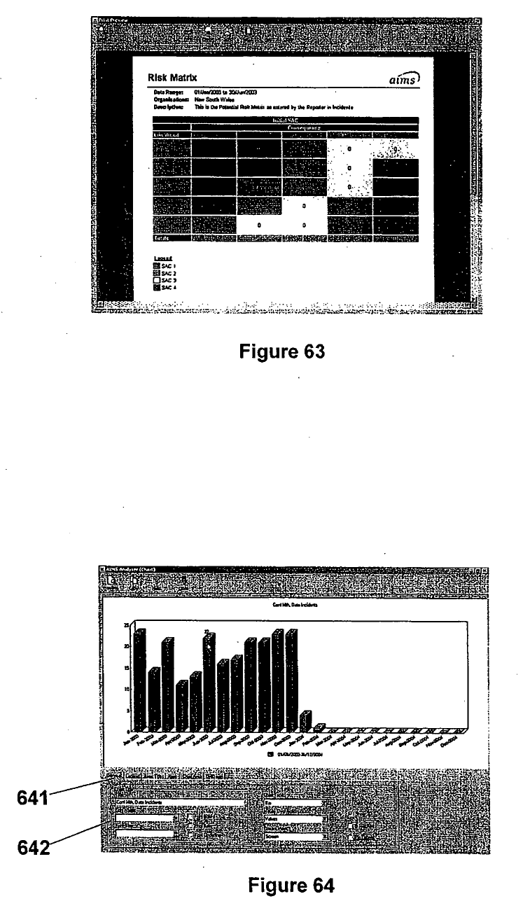

Classification of incidents is one of the fundamental features of this invention, which is explained in the following exemplary description. With reference to the earlier description of the Runciman classification model 42, this embodiment of the invention implements the classification concept in the form of an extensible hierarchical classification structure. FIG. 60, FIG. 61, FIG. 62 and FIG. 63 illustrate the general structuring concept. In this embodiment of the invention, at the highest level of the hierarchical structure occur the “Classification Groupings” 62, which are a convenient means for ordering and arranging the lower level classifications into logical groups, in this exemplary illustration it can be seen that the “Therapeutic Agent/Nutrition” Classification Grouping 61, contains lower level classifications for “Medications/IV Fluids” 63, “Blood and Blood Products” 64, “Oxygen/Gases/Vapours” 65, “Nutrition” 66, which are all forms of “Therapeutic Agents” or “Nutritional” factors, hence their association in this “Classification Grouping” 61. The classifications at this level (“Medications/IV Fluids” 63, “Blood and Blood Products” 64, “Oxygen/Gases/Vapours” 65, “Nutrition” 66) are known in this embodiment of the invention as “HITs” (“Health Incident Types”). It must be understood that no restriction in the arrangement of classifications into Classification Groupings is implied by this exemplary illustration.

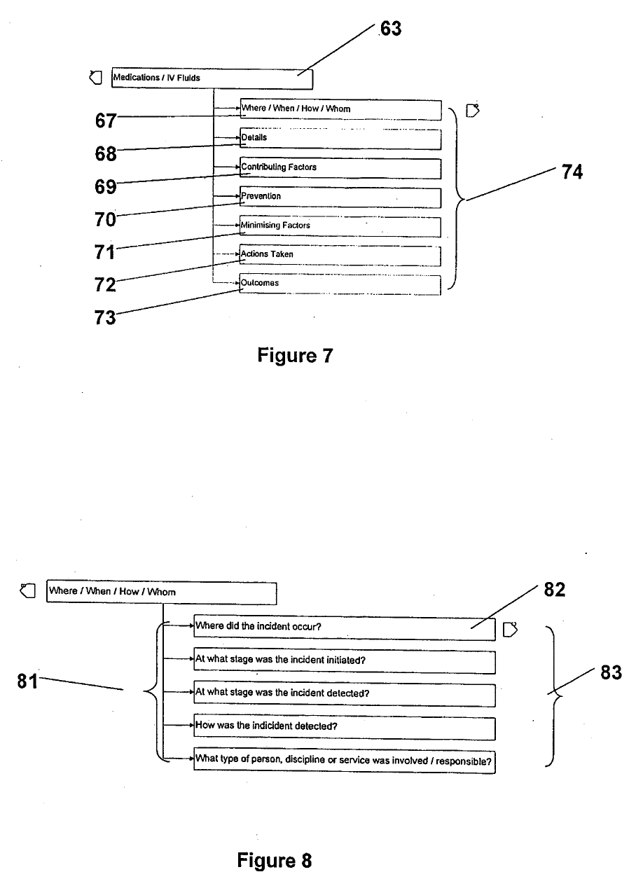

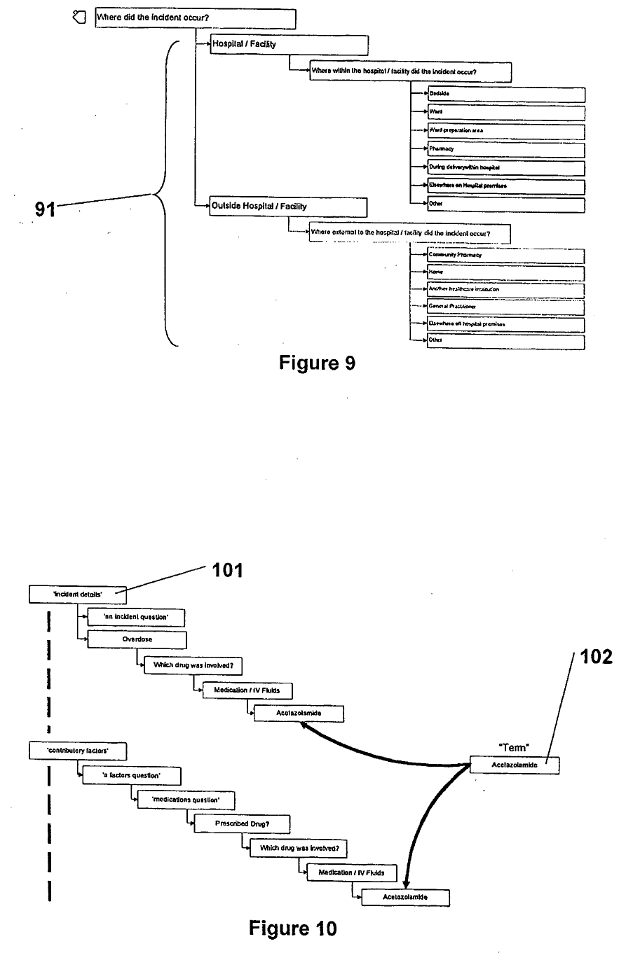

Following the “Medications/IV Fluids” classification branch 63 (from this point forward the phrase “Classification Branch” may be used synonymously with the term “HIT” and vice versa) leads to FIG. 7. It is apparent from the illustration in FIG. 7 that the “Medications/IV Fluids” classification 63 contains a number of lower level branches, which in this exemplary illustration are “Where/When/How/Whom” 67, “Details” 68, “Contributing Factors” 69, “Prevention” 70, “Minimizing Factors” 71, “Actions Taken” 72, and “Outcomes” 73. In this embodiment of the invention this level of branches in the classification hierarchy are standardized categories, termed “Primary Classification Categories” 74. These Primary Classification Categories 74 reflect the key components of the Runciman classification model 42 described earlier. Selecting the “Where/When/How/Whom” 67 category leads to the first level of hierarchical classification questions, which are known in this embodiment of the invention as “Main Questions”, as illustrated at 81 in FIG. 8. Because of the extensible nature of the hierarchical structure there may be many such classification questions 83 at this level. For clarity, a Main Question 81 is an instance of a “Term” 52 used in this context in the hierarchical structure to pose a question. In this exemplary illustration, the Figure shows that the Term 52 “Where did the incident occur?” 82, has been used in context to question the user about the details of the incident location. Similarly, the lower level branches, nodes and leaves below “Where did the incident occur?” are Terms 52 used in context to provide an increasingly specific definition of the incident, as is illustrated at 91 in FIG. 9. As the hierarchical structure is extensible there may be many such sub-branches, nodes and leaves posing increasingly specific questions to achieve the desired level of classification. The extensibility of the hierarchy is the fundamental concept in this embodiment of the invention, whereby the defined Terms may appear at any point in the hierarchical structure, the context for which provides the absolute context definition of the Term. Referring to our description of Terms earlier, a Term is not restrictive; it may be a word, or question, a phrase, a name, or other similar abstraction. This principle of absolute context for the Term is illustrated simply in FIG. 10. The Figure shows a portion of an exemplary classification hierarchy 101, with two distinctly different contexts, one being related to details of an incident itself, the other being related to the contributory factors that may have played a part in the incident. A Term 52, which in this case happens to be the agent “Acetazolamide” 102, has been defined in the System. It is apparent from the figure that the Term 52 has been used in two entirely different contexts within the classification; in one case to identify which drug was given in overdose, and in the other context the drugs that the patient may have been taken under prescription and which may therefore have been a contributory factor in the overdose incident. It is apparent that the several branches traversed to navigate to the Term “Acetazolamide” 102 are quite different in each case. This illustrates that the Term may be positioned any number of times, wherever it is required in the hierarchical classification structure, and that the context of each instance of the Term is entirely different. It is clear from this illustration that the System does not therefore have a rigid structure, but that it instead can be extended, with as many Terms and context specific instances of Terms as desired for classification purposes.

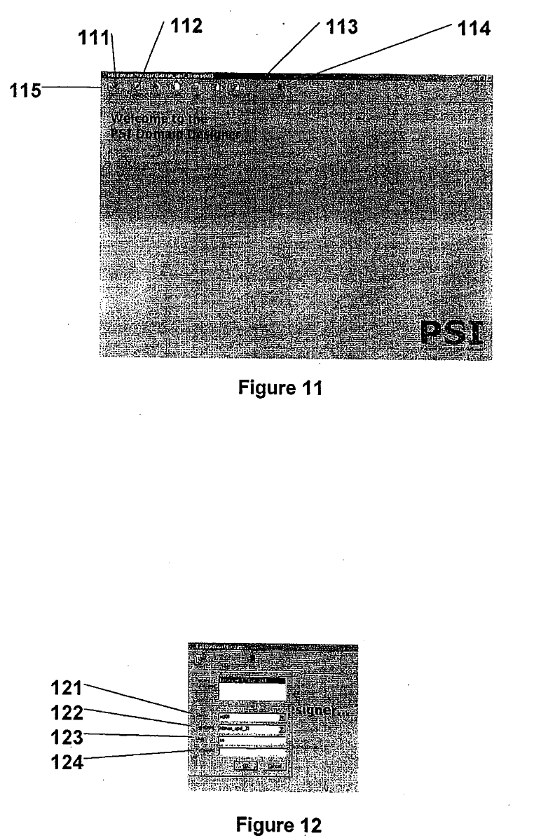

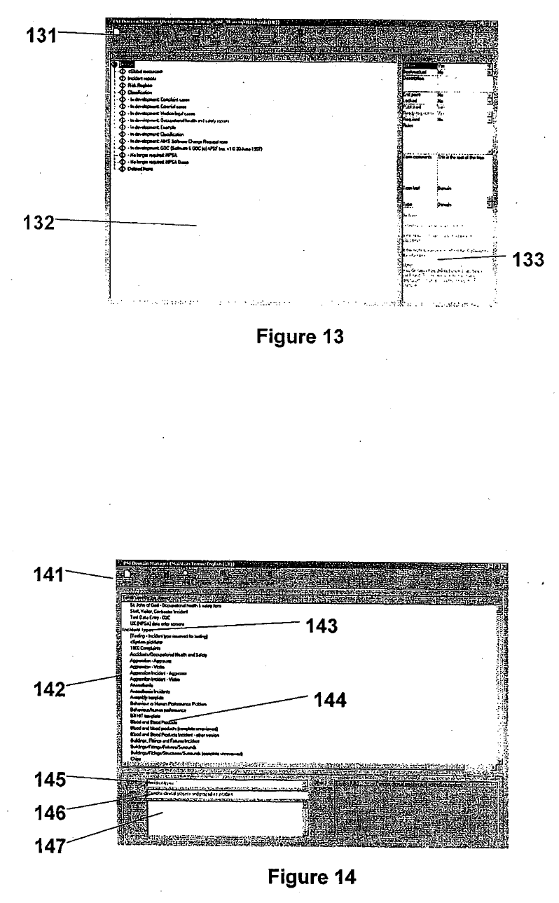

As described earlier, in this embodiment the System 1 is modular in nature, with different modules providing specific features of the system. We describe here the main features of this embodiment of the invention relating to the hierarchical structure generation and management module 32; the main purpose of which is to allow the creation, modification and management of the data items and hierarchical structures that underpin this invention. FIG. 11 illustrates the “Welcome screen” generated when the user starts the hierarchical structure generation and management module of the System. In order to carry out functional actions within the module the user must first log on by “pressing” or “clicking” the Open button 111 using the input device, which in the preferred embodiment is a computer mouse or similar on-screen pointing device. Upon activation of the Open button 111, a logon screen appears as shown in FIG. 12. The logon screen requires the user to input logon credentials in the form of Server 121, Database 122, User 123 and Password 124, details of which will have been supplied to the user by an administrator of the System 1. Entering valid credentials into this screen affords the user access to the main hierarchical structure generation and management module functions. Returning to FIG. 11, the user can select a number of options for creating, editing and maintaining the data elements along with other administrative aspects of the hierarchical structure generation and management module via the buttons listed at 115. It should be noted that in this exemplary illustration we concentrate our description on those elements of the hierarchical structure generation and management module that support the core principles and concepts of the invention, rather than the general features and functions of the system which could be expected to be similarly incorporated into another embodiment by anyone skilled in the art, for example Help 113 (providing textual on-screen guidance and assistance to a novice) and Exit 114 (to close the module and thereby exit the system). By clicking the Design button 112 the user selects the main data element maintenance screen within the hierarchical structure generation and management module as illustrated in FIG. 13.

The main data element maintenance screen is subdivided into two principal sections “Domain Structure” 132 and “Node Properties” 133. Arranged at the top of this screen are a number of function buttons 131 which allow the user to respectively; create new data element items, edit data element items, manage the data element item positioning, manage Term data elements, view alternative presentations of data elements, debug data elements definitions, view help information in context, and to close down the hierarchical structure generation and management module.

The “Domain Structure” section 132 houses a visual representation of the data elements held in the System database and in this embodiment is in the form of an extensible hierarchical tree as will be apparent from the further descriptions in this document. The “Node Properties” section 133 houses the attributes of each of the data elements represented in the Domain Structure section 132. The attributes of each of the data elements are displayed when an item in the “Domain Structure” section 132 is selected by clicking with the input device. Different types of data elements from the Domain Structure section 132 will exhibit different attributes in Node Properties section 133, according to the item selected.

A basic principle of this invention is the definition and arrangement of data elements within the Domain Structure, as visualized in the Domain Structure section 132; these give rise to the flexible data collection and data classification capabilities of the System. The arrangement of data elements forms an extensible hierarchical structure, akin to a naturally occurring tree with roots, trunk, branches and leaves; in this analogy one. can conceive the extensible nature of the data element hierarchical structure as synonymous with the extensibility of branches and leaves of a tree. In this embodiment the terms branch, nodes and leaves are used to describe the arrangement of data elements in the hierarchical manner, with a branch referring to any junction, a node referring to any intermediate level of the hierarchy and leaf referring to lowest level of detail. An exemplary illustration of this concept can be seen in FIG. 10.

The data elements that form this tree are created firstly as basic Terms 52 within the System 1. A Term is not restrictive; it may be a word, or question, a phrase, a name, or other similar abstraction. As an analogy, one can consider “Terms” as synonymous with words and phrases in, say, the English language. These Terms are grouped into logical types representing their differing usage in this embodiment of the invention. FIG. 14 illustrates some instances of the Terms defined in this embodiment of the invention at 142, and illustrates the basic grouping of the Terms under, in this example, the grouping “Incident Types” 143. It should be understood that the list of Terms defined within the system is extensible with new Terms being added as necessary. Adding new Terms to the list is achieved by clicking the New button 141 and completing the details at the bottom of the screen in Group 145, Term 146, Comments 147 as desired.

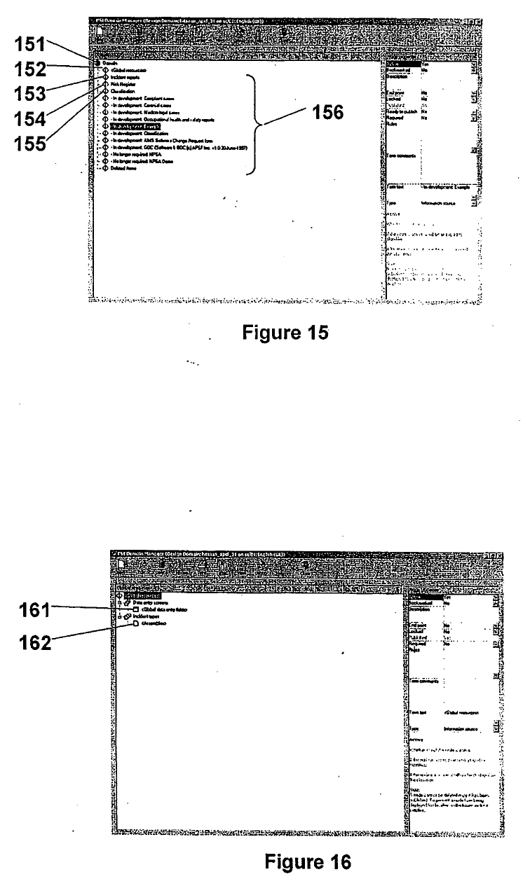

Once a Term 144 has been defined, it is used in the hierarchical structure referred to above and as described here in detail. FIG. 15 illustrates a typical embodiment of the top level of a hierarchical structure. As can be seen from the Figure, in this embodiment the top level or root of the tree is known as “Domain” 151. Below it are listed the principal branches of this exemplary illustration 156. It should be understood that the list is not restricted to those branches identified in this illustration, but that it is extensible allowing definition of as many further branches as necessary. In this embodiment of the invention, a number of principal branches have been standardized for organization and convenience purposes. They are “<Global Resources>” 152, “Incident Reports” 153, “Risk Register” 154, “Classification” 155. The usage of these standardized branches is set out here for clarity. The “<Global Resources>” 152 branch houses definitions and arrangements of Terms 144 into “Data Entry Fields”. (A “Field” is commonly understood by anyone skilled in the art as a means for capturing data from a user input device and for storing the captured data either temporarily or permanently for the purpose of the system processing the data. We also use the word “Field” more generally in regard to Fields grouped into Sections and Tab pages.) The “Incident Reports” 153 branch houses the collections of “Data Entry Forms” (a “Form” being commonly understood by anyone skilled in the art to mean an on-screen arrangement of Data Entry Fields). The “Risk Register” 154 branch houses a collection of Forms specifically relating to the concept widely understood by anyone knowledgeable within the field of “risk” to mean risk assessment, evaluation and management processes. The “Classification” 155 branch houses the hierarchical arrangement of Terms 144 relating to the classification of incidents recorded by the System.

Each principal branch, just so described, can be expanded by double-clicking the branch with the on-screen pointing device (“double-clicking” being a form of confirming on-screen selection with a pointing device; in other embodiments of the invention this may be achieved via different device-specific means). This opens the branch to the next level of detail below, as illustrated in FIG. 16. In this exemplary illustration there are two branches, each with a lower level branch “<Global data entry fields>” 161 and “<Assemblies>” 162.

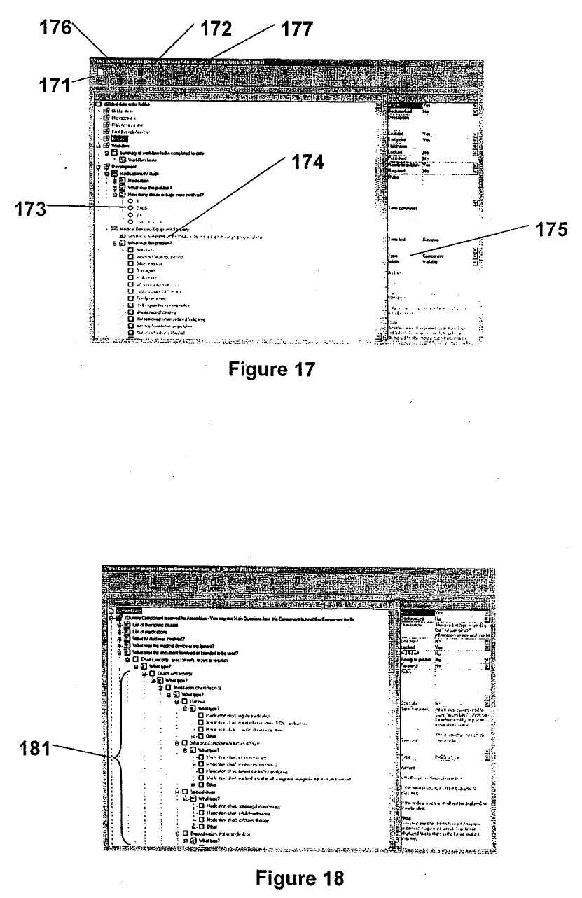

Turning firstly to the “<Global data entry fields>” 161 branch, “Double Clicking” on the branch opens it, exposing the lower level branches, nodes and leaves as illustrated in FIG. 17. It is apparent from FIG. 17 that there may be many such lower level branches, nodes and leaves contained within this visual representation, FIG. 17 representing just one such exemplary arrangement. In this arrangement, Terms 144 created within the system are used here to define “Data Entry Fields”. A new Data Entry Field 174 may be created at any point in the hierarchical view by clicking the New button 171, choosing the appropriate Term 144 from the list as illustrated in FIG. 14, and adding it to the current branch. The Data Entry Field's attribute information is then completed to specify the behaviour of the Data Entry Field, including attributes such as the type of field at “Type” 175. It is apparent from the visual display of the branches, nodes and leaves that different icons 173 represent the different types of fields defined within the hierarchy (“icon” being commonly understood by anyone skilled in the art to mean a small graphical element, usually pictorially or abstractly representing the object with which it is associated). Such “icon” notation is further used throughout this embodiment of the invention to illustrate different types of elements. Data Entry Fields may also be removed from any point in the hierarchical view using the Delete button 172, and Data Entry Fields may be edited using the Edit button 176 to initiate the edit process. Turning secondly to the “<Assemblies>” 162 branch as illustrated in FIG. 16, double-clicking on the branch opens it, exposing the lower level branches, nodes and leaves as illustrated in FIG. 18. In this embodiment of the invention “Assemblies” 162 are re-usable sections of a hierarchical structure, created for the purposes of convenience. An Assembly 162 may be created when it is deemed that the data elements are likely to be used in more than one place within the overall hierarchical structure. For the purposes of illustration it may be contemplated that a definition of, say a piece of equipment, its characteristics and its components may be required in a number of places within a hierarchy to allow a user to describe on the one hand a piece of equipment that broke, or on the other hand to describe a piece of equipment that struck a person. Arranging the definition of items of equipment in an Assembly 162 conveniently allows a single equipment definition to be re-used in multiple contexts within the overall hierarchy. It will be apparent from FIG. 18 that Assemblies 162 are used, in this embodiment of the invention, to hold a variety of lists of information such as equipment, medications, parts of the body, locations, along with more hierarchical arrangements of Terms 144 as illustrated in the Figure at 181. It can be contemplated by anyone skilled in the art that such lists are illustrative of this exemplary description and are not therefore an explicit definition of the limitations of the invention. New Assemblies may be readily constructed, or existing Assemblies edited in the manner described above for “<Global data entry fields>” 161.

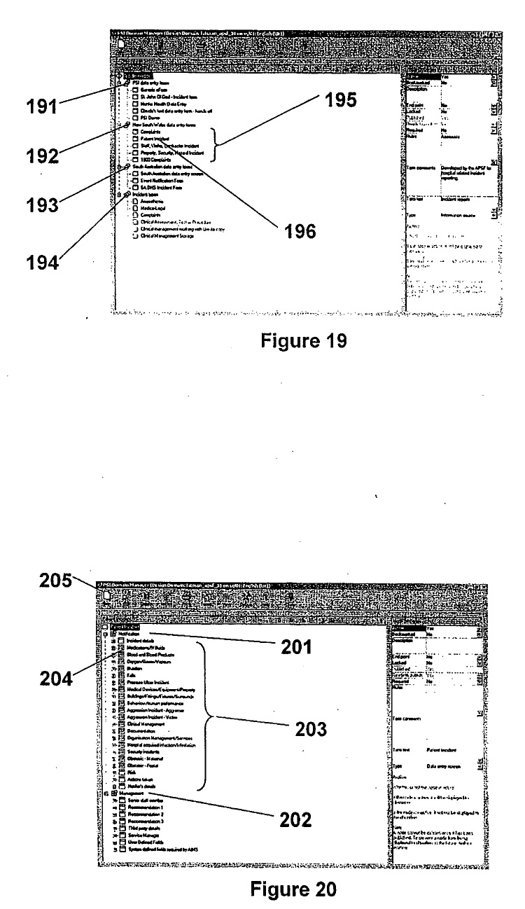

Turning again to FIG. 15 and the “Incident Reports” branch 153 we now set out the preferred embodiment's mechanism for creating and maintaining Data Entry Forms within the hierarchical structure. The Data Entry Forms created here are for use within other System modules including but not limited to the Data Manager module 33. Double-clicking on the “Incident Reports” branch 153 opens it, exposing the lower level branches, as illustrated in FIG. 19. In this exemplary illustration there are a number of immediate branches representing groups of data entry forms 191, 192, 193 and 194, with the data entry forms 195 belonging to the group 192 listed under the group heading. Double-clicking on the “Patient Incident” branch 196 within the “New South Wales data entry forms” group 192 opens it, exposing the next level branches which define the “Patient Incident” Data Entry Form, as illustrated in FIG. 20. In this illustration, there are two items listed at this branch level: “Notification” 201 and “Management” 202. These two branches have a Type attribute that causes them to appear as separate “Tabs”, or “Tab Pages”, in the “Patient Incident” Data Entry Form of the Data Manager module 33 (“tabs”, or “tab pages” being commonly understood by anyone skilled in the art to mean a visual representation of a large form as two or more forms, typically with a main form at the front, the remainder hidden behind and being accessible via a protruding description or box at the top or side of the main form known as the “tab”). It is readily contemplated that there may be any number of branches existent within each branch and that “tabs” are only one of the mechanisms whereby a large amount of information may be organized for convenient presentation to the user.

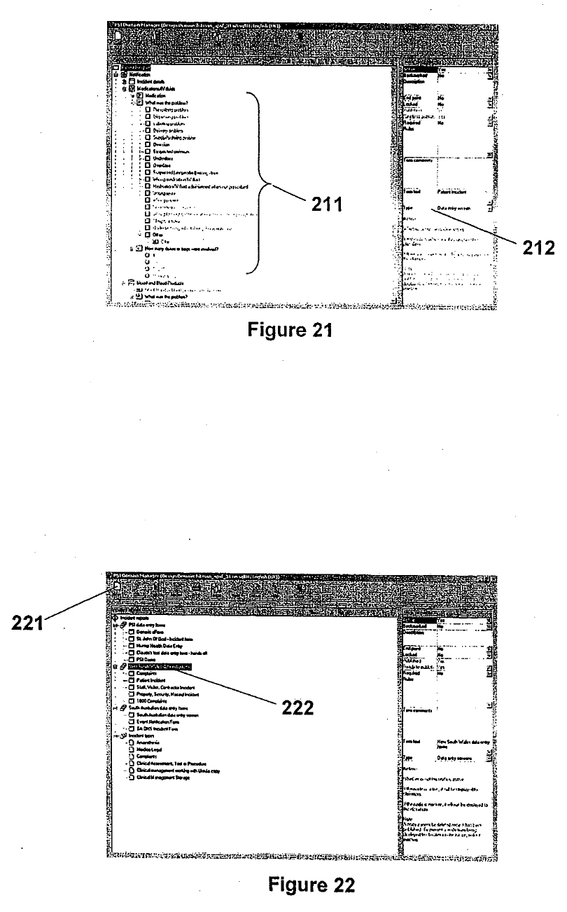

FIG. 20 also illustrates the hierarchy branches 203 that define the sections of the exemplary “Notification” 201 tab page of the in the “Patient Incident” Data Entry Form. These branches have a Type attribute 212 that causes them to appear as separate Sections 203, each with a section heading and one or more data entry fields. Type attributes 212 of Sections 203 also specify whether they are always displayed or displayed only for specified incident types 194. Double clicking on the “Medication/IV Fluids” branch 204 opens it, exposing the lower level branches, nodes and leaves 211 as illustrated in FIG. 21. The lower level branches, nodes and leaves each specify a previously defined Data Entry Field 174 in the section 203 of the form.

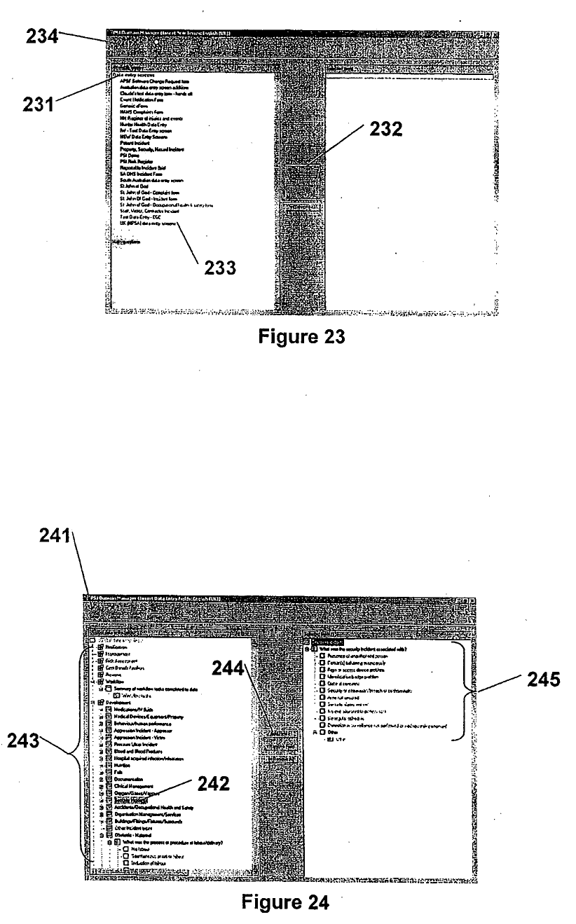

Referring to FIG. 19, new Groups of Data Entry Forms and individual Data Entry Forms may be readily created by clicking on a branch within the hierarchical structure and clicking on the New button 171. In the exemplary illustration at FIG. 22, the Data Entry Form Group “New South Wales Data Entry Forms” 222 branch is selected and the New button 221 clicked, opening the Term Selection screen at FIG. 23 displaying a list of previously defined Data Entry Forms 231 from which a Data Entry Form name may be selected by highlighting the preferred Term 233 and clicking the “Add Term” button 232. After the Save button 234 is clicked, the Term 233 for the new Data Entry Form then appears with the other Data Entry Forms in the currently selected branch. With reference to the earlier description of Term definition, the Term must have previously been created in the appropriate section of the Terms list 142 in FIG. 14, in this exemplary illustration the “Data Entry Screens” section.

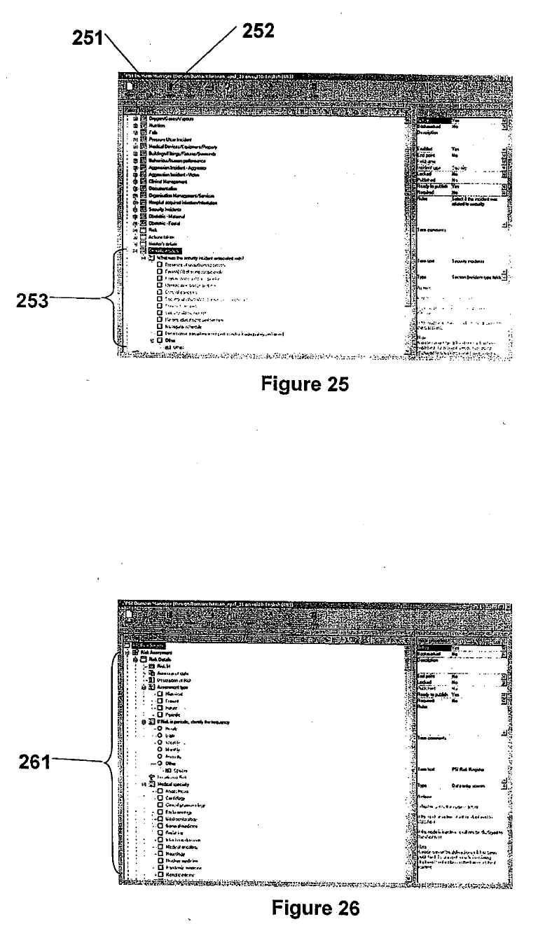

Referring to FIG. 20, “Data Entry” fields are created on the “Data Entry Form” by selecting a “Data Entry Form” from the current branch list, for example “Notification” 201, and clicking the New button 205. This causes the Insert Data Entry Fields screen to be displayed as shown in FIG. 24. Choosing a Data Entry Field or an Assembly from the “Data Entry Fields” list 243, in this example “Security Incidents” 242 enables the “Add Field” button 244, which upon clicking adds the “Data Entry Field”, branch, or “Assembly” into the “Selected Fields” panel 245. In this example the entire “Security Incidents” branch 242 from the “Data Entry Fields” list 243 has been added. Saving the definition via the Save button 241, places the selected fields into the Data Entry Form as illustrated in FIG. 25 at 253. When desired, any of the “Data Entry Fields”, branches, or “Assemblies” present in the Data Entry Form may be edited or removed from the form using the “Edit” 251 or “Delete” buttons 252.

Turning again to FIG. 15 and the “Risk Register” branch 154. In this embodiment of the invention the “Risk Register” is a Data Entry Form, constructed in the manner of all other Data Entry Forms within the System, but is separately identified for the specific purposes of capturing risk related assessment, evaluation and management information. Having selected the “Risk Register” branch it is apparent from FIG. 26 that the Risk Register Data Entry Form 261 is merely an exemplary illustration and no restriction to the scope of the Risk Register is thereby implied.

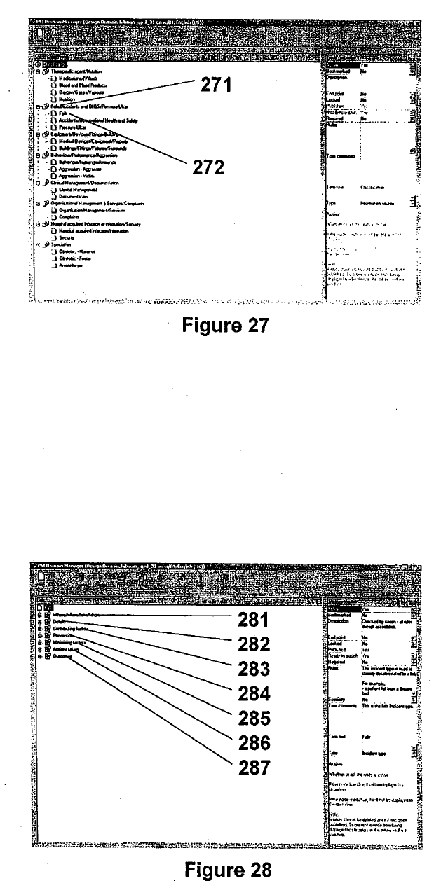

The concept of the hierarchical classification structure as illustrated in FIG. 10 and described above is embodied in this invention in the “Classification” principal branch 155, located below the top level “Domain” FIG. 15. Selecting the “Classification” principal branch 155 leads to the list of “Classification Groupings” 271 and “Classifications” 272 as shown in Figure .27. There can be many “Classifications” (“HITs”) defined in the System; FIG. 27 lists an exemplary illustration; no restriction as to the scope of classification is implied by this illustration. Indeed, in the preferred embodiment of this invention, the number of branches implemented to provide a comprehensive and in-depth classification of health and safety incidents has grown to many hundreds of thousands. The use of the hierarchical structure generation and management module is however designed to allow such very large numbers of branches to be managed and used efficiently and reliably.

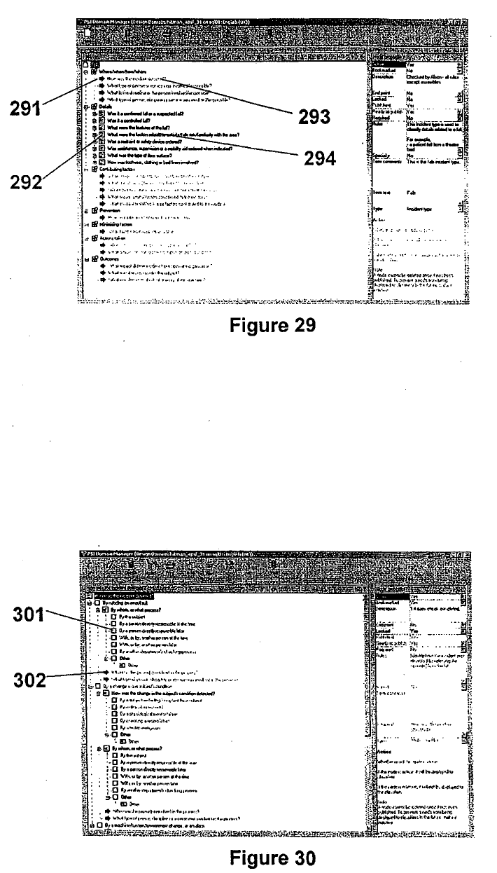

In FIG. 27, selection of the “Falls” classification 272 from the list yields the Primary Classification Categories 74 relevant to this level of the classification as shown in FIG. 28. In the preferred embodiment, the Primary Classification Categories 74 are “Where/When/How/Whom” 281, “Details” 282, “Contributing Factors” 283, “Prevention” 284, “Minimizing Factors” 285, “Actions Taken” 286, and “Outcomes” 287. Expanding each of these branches in turn yields the “Main Questions” relevant to each Primary Classification Category 74, as illustrated in FIG. 29. It is apparent from this exemplary illustration in FIG. 29 that the Main Questions displayed within each Primary Classification Category 74 display differing Icons 291 and 292, the differences being a function of the manner in which the “Main Questions” 293 and 294 were originally created. To explain, the arrow-shaped icon 291 signifies in this embodiment of the invention that the “Main Question” is derived from an Assembly (described earlier in this text) that may therefore contain a series of already defined sub-branches, nodes and leaves. The ability to Use assemblies in the definition of classifications of course saves time when creating a large, comprehensive hierarchical classification structure. It also ensures consistency of usage. Similarly, icon 292 signifies a branch assembled in situ using individual Terms from the previously created Terms list 142. Selecting the “How was the incident detected?” branch 293 displays the contents of this branch as illustrated in FIG. 30. Again, different icons 301 and 302 signify the different types and behaviour of classification items.

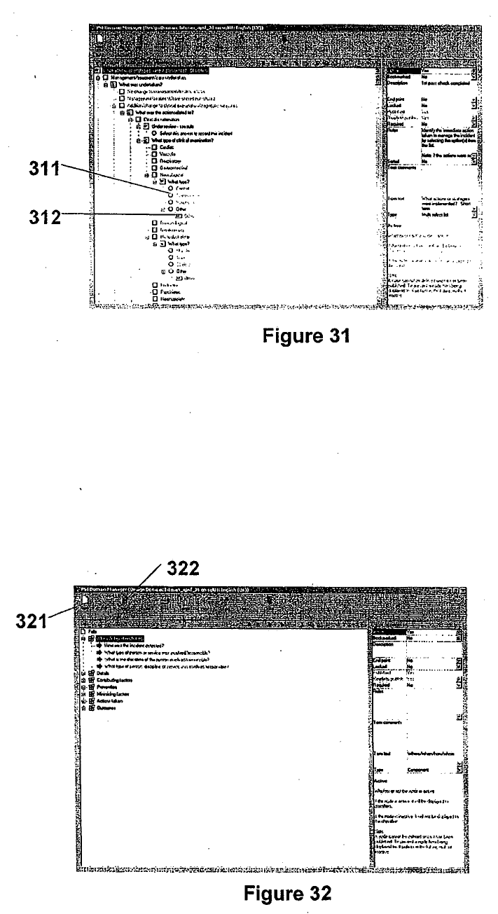

In this exemplary illustration, the “By a person directly responsible later” item 301 acts as a checkbox user response field (“checkbox” being commonly understood by anyone skilled in the art to mean an on-screen user response data field which, when clicked, displays a check or tick mark to signify a positive selection, commonly used to indicate a non-exclusive selection from a list of items). Other forms of user response fields used in this embodiment of the invention include, but are not limited to “radio button” 311 and “text entry” 312 as illustrated in FIG. 31. (“radio button” is commonly understood by anyone skilled in the art to mean a circular on-screen user response data field which when clicked becomes shaded to signify positive selection, commonly used to indicate an exclusive selection from a list of items. “Text entry” is commonly understood to be a data field for the purpose of capturing alphanumeric data entry). It will be apparent from the illustration at FIG. 30, that lower level branches may also contain Assemblies, as shown here at 302, and therefore any combination of Assemblies and in-situ defined classification items at any level may be created. This illustrates the flexible, extensible nature of the hierarchical classification structure.

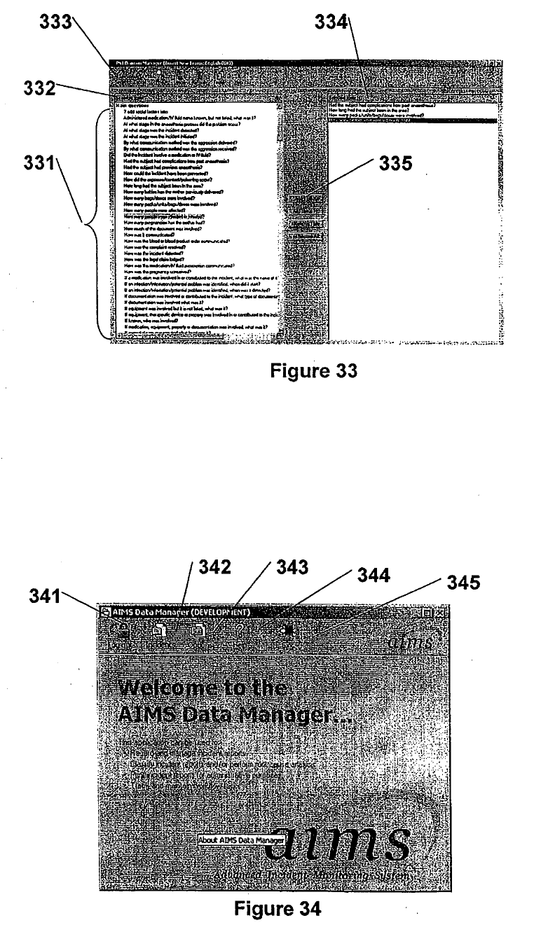

For completeness, the mechanism for creating in-situ classification items is set out here using FIG. 32 as a starting point. To create a new classification item, at whatever level so desired in the hierarchical structure, a branch, node or leaf in the hierarchy is first selected; in this exemplary illustration the “Where/When/How/Whom” Primary Classification Category 74 within the “Falls” classification hierarchy (HIT). To create a new item, the “New” button 321 is clicked to display the Terms Selection screen as illustrated in FIG. 33. In this exemplary illustration, the Main Question section 331 of the Terms list is displayed in the left hand panel by default since the level in the hierarchy in which we are currently seeking to create the new item is naturally the Main Question level. It is implicit therefore that the Terms list defaults to different sections according to the currently selected level. Choosing a Term from the “Available Terms” list 332 and clicking “Add Term” 335, adds the Term to the “Selected Terms” panel 334, whereupon it may be committed to the classification hierarchy by clicking the Save button 333. Likewise, classification elements may be deleted from the classification hierarchy by selecting a classification item, branch, node or leaf and clicking the Delete button 322 in FIG. 32.

The hierarchical structure described in this embodiment by the exemplary illustrations set out above is stored in the Database according to this embodiment 2. All the modules of he System 1 utilize information stored in the Database, including the hierarchical structure, in the performance of their functions.

In this embodiment of the invention the hierarchical structure may be output to a printing device using the Print button 177 at any point in the hierarchical structure to print the current branch, and its lower level branches, nodes and leaves.

The creation, manipulation and management of the hierarchical structure in this embodiment of the invention, is the preserve of the hierarchical structure generation and management module 32 of the System. It can be readily contemplated by anyone skilled in the art that this functionality could be incorporated differently in other embodiments.

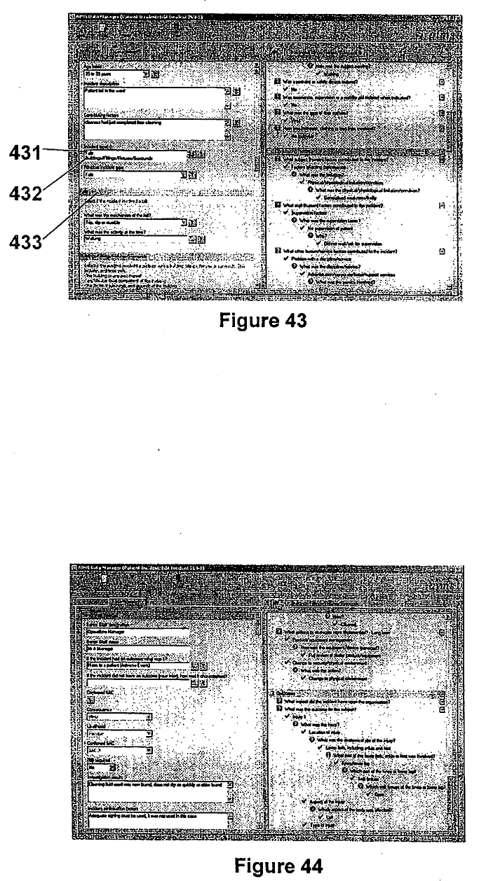

As described earlier, in this embodiment the System 1 is modular in nature, with different modules providing specific features of the system. We describe here the main features of this embodiment of the invention relating to the Data Manager module 33; the main purpose of which is to provide data entry facilities, notably for Indecent data entry. Shown in FIGS. 34 to 54 is a preferred embodiment of the Data Manager module 33. This module is shown in the context of the overall System in FIG. 1.

Shown in FIG. 34 is the initial screen displayed when the user starts the Data Manager module. To proceed, the user must first select the login button at 341 and enter a valid database reference, user name and password. Throughout the Data Manager module, security rules previously assigned to the user are applied in order to authorize each user to see and use only appropriate data and actions. These security rules are defined by an system administrator using the Administrator module 36. Until the user has entered a valid user name and password, only the Login 341, Help 344 and Exit 345 buttons are visible. After the user has entered a valid user name and password, an Incidents button 342 and Options button 343 appear on the screen. The Options button 343 allows the user to select preferred data viewing options such as wide or narrow views of the data on screens. The Help button 344 and Exit button 345 throughout the system perform the usual functions common in systems with a window-based user interface, as will be understood by anyone skilled in the art.

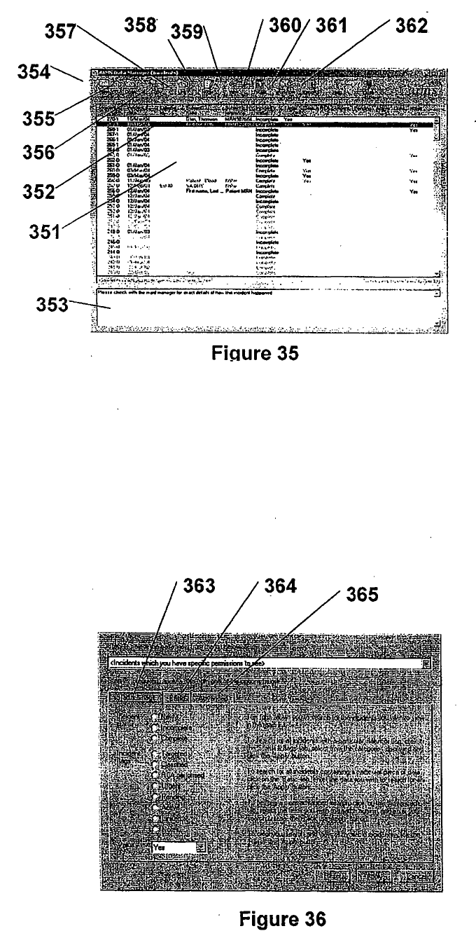

When the user selects the Incidents button 342, the Incidents console-screen as shown in FIG. 35 is displayed. This screen contains a list 351 of all the incidents 352 that the user has been given authority to see. When the user clicks on an incident row 352 in this list, a Notes panel at the bottom of the screen displays any notes 353 that have been previously entered for this incident. The screen contains several buttons labelled New 354, Open 355, Copy 356, Link 357, Notes 358, View 359, Totals 360, Workflow 361, and Reports 362. These buttons allow the user to select further specific actions as described below.

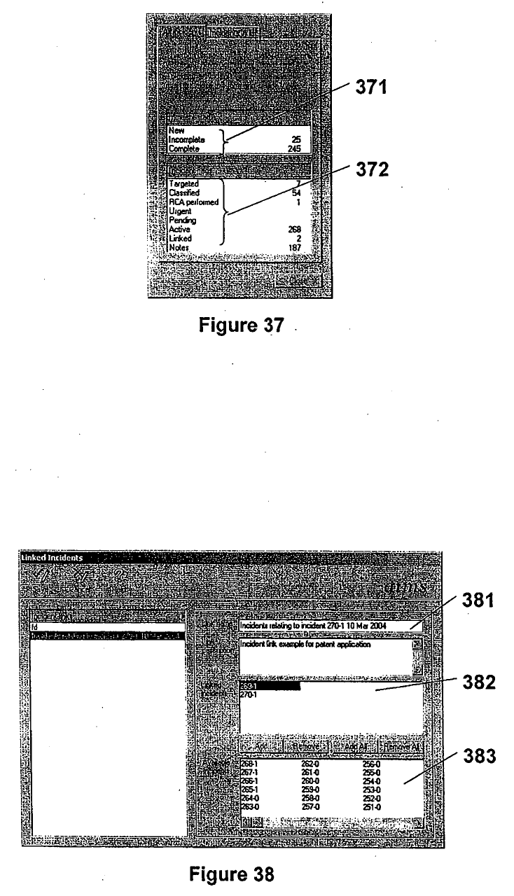

When the user selects the View button 359, a View Selection screen appears as shown in FIG. 36. The user may select one of the tabs labelled Status and Flags 363, Basic 364 or Advanced 365, to select or limit the list of incidents displayed in the Incidents console screen. When the user selects the Totals button 360, a Totals, screen appears as shown in FIG. 37. The Totals screen shows the user how many incidents with each status 371 are present in the database and how many incidents with each flag value 372 are present in the database.

When the user selects the Notes button 358, a data entry box appears and allows the user to add or modify the incident notes 353 which may contain text about the incident or about the data or both.

When the user selects the Links button 357, a screen as shown in FIG. 38 appears and allows the user to establish or modify links between incidents that are related. An example is an incident in obstetrics that affects a mother and her baby. Each link is given a Link Name 381, a description and a list of Linked Incidents 382 can be defined by selecting incidents from the list of Available Incidents 383.

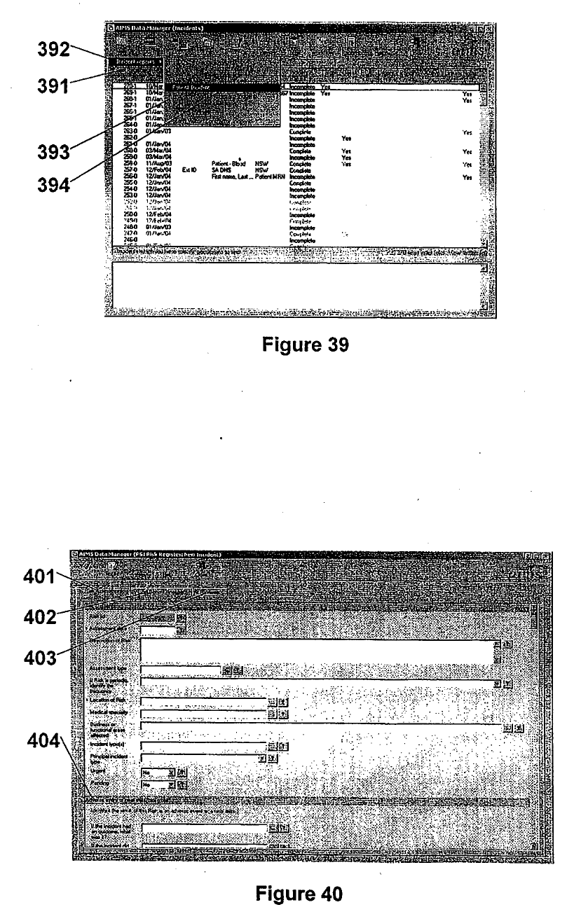

When the user selects the New button 354, the New Incident selection options appear as shown in FIG. 39. These appear as a menu list allowing the user to select either Incident data entry 391 or Risk Register 392.

When the user selects Risk Register 391, the Risk Register data entry screen is displayed as shown in FIG. 40. This screen allows the entry and maintenance of incident risk data as distinct from specific incident data. The large amount of data is organized by use of tabs, for example Risk Assessment 401, Cost Benefit Analysis 402 and Reviews 403 and by grouping the data items under headings 404. The design of the Risk Register screen and the storage of Risk Register data in the Database according to this embodiment are performed by the same methodology as used for Incident data as described below.

When the user selects Incident data entry 392, a second list of available Incident Data Entry screens 393 appears. These screens are tailored to various general purposes or to customers' specific requirements. Although these screens are tailored, they are all generated consistently using the hierarchical structure generation and management module 32 and are all based on a single underlying data definition structure as described further in the description of the hierarchical structure generation and management module 32.

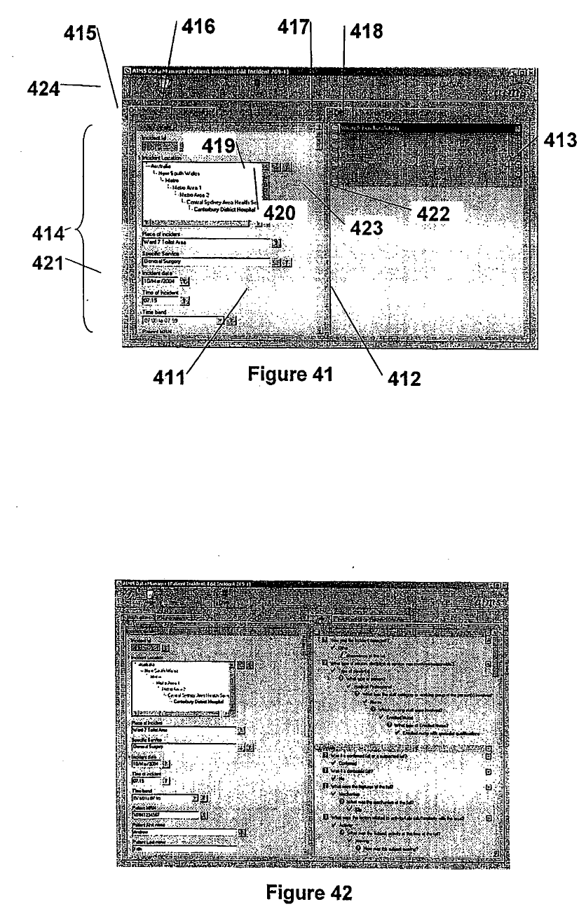

When the user selects an entry, for example Patient incident 394, in the list of available Incident Data Entry screens 393, the selected data entry screen is displayed as shown in FIG. 41. The exemplary Patient Incident data entry screen is illustrated in FIGS. 41, 42, 43 and 44. This screen is a representative embodiment of the preferred implementation and illustrates many of the features of the invention.

The Patient Incident data entry screen shown in FIG. 41 allows the user to enter details of a new incident. The screen contains two sections side by side. The left side 411 contains a large and variable number of data entry fields 414 on two pages identified by tabs 415 and 416, which the user can select by clicking the tabs. The right side 412 contains one or more pages identified by tabs 417 and 418, which the user can select by clicking the tabs. The contents of the left and right sides are now described in more detail.

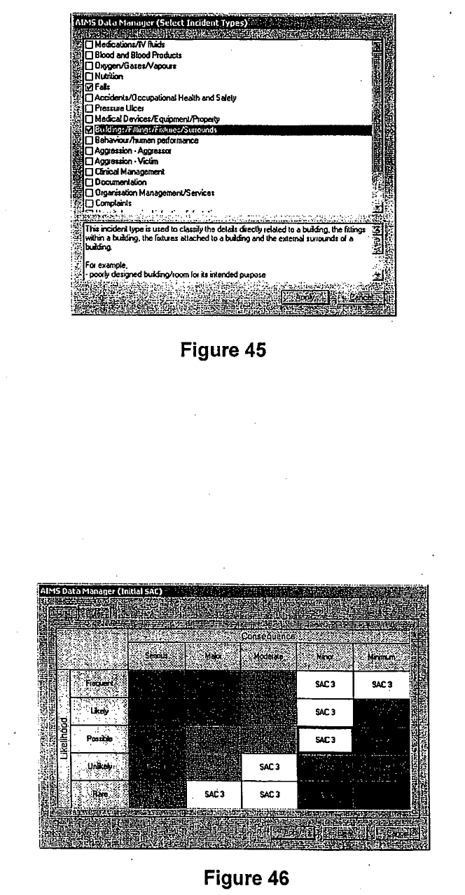

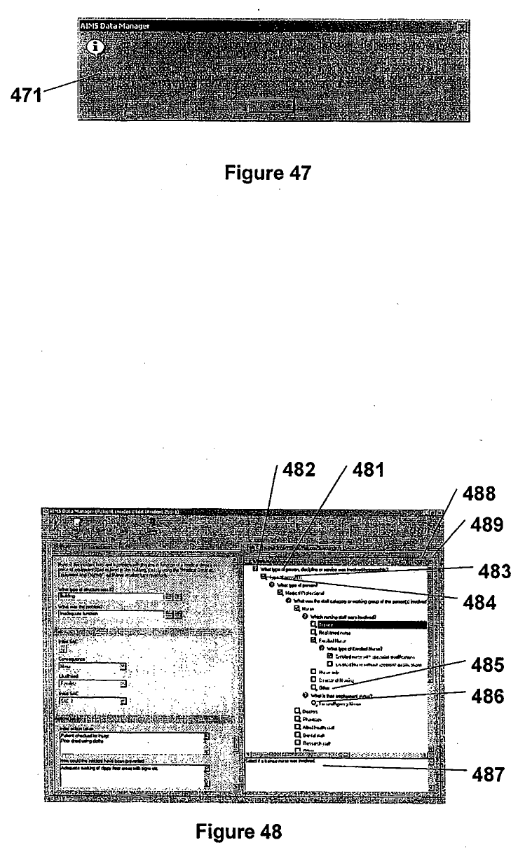

The left side data entry form 411 initially displays only basic fields 414 for entry of data describing the location, time and description of the incident and the persons affected. These fields are initially empty and FIGS. 42, 43 and 44 show an example of some of the Patient Incident data entry screen after an incident has been entered. Many fields contain buttons 419, which the user may select to display lists of values that the user is allowed to enter into the field. Many of the lists of values are multi-select lists as shown in FIG. 45, to enable the user to select more than one value in the list. Some lists of values are complex, for example the risk data entry matrix as shown in FIG. 46. Many fields also have a Rule Button 420 labelled with a question mark. When the user selects a Rule Button 420, an appropriate block of text 471 as shown in FIG. 47 is displayed. The text 471 displayed is as defined in the screen designer data definition structure in the hierarchical structure generation and management module 32 and are stored in the Database according to this embodiment 2. When a value “Other” is selected, a further text box appears on the data entry form 411 and requires the user to enter some text associated with the value “Other”. When the user selects an Incident Type 431, e.g. Falls, a set of additional data entry fields 433 specifically for that incident type is made visible on the data entry form. If a further Incident Type 432 is selected then a further set of additional data fields 433 is made visible on the form. Some data entry fields, e.g. Incident Date, are specified as mandatory and are highlighted by markers 421 on the form. These specifications are included in the form by the form designer using the hierarchical structure generation and management module 32 and are stored in the Database according to this embodiment 2.

Until the user selects an Incident Type 431, on the left hand side data entry form 411, the right hand side 412 remains blank. When the user selects an Incident Type 431, e.g. “Falls”, a tab page 417 for that Incident Type 431 is made visible on the right hand side 412. This tab page 417 contains the complete hierarchical classification branch 61 (refer FIG. 6) for the selected Incident Type 431 from the master hierarchical classification structure 57 (refer FIG. 5) as created and maintained using the hierarchical structure generation and management module 32. If a further Incident Type 432 is selected on the left hand side data entry form 411, then a further tab page 418 for each Incident Type 431 is made visible on the right hand side 412. Each tab page 417 on the right hand side 412 contains the complete hierarchical classification branch for the selected Incident Type 431 from the hierarchical classification structure 57 as created and maintained using the hierarchical structure generation and management module 32. Depending on client preferences and user access permissions, a pre-defined “Basic” subset of the hierarchical classification structure 57 may be displayed instead of the full classification.

The hierarchical classification branch 413 for the selected Incident Type 431 on the right hand side is displayed in an extensible visual representation of the hierarchical structure. This visual representation is similar to what is commonly known by those skilled in the art as a “Tree View”. It differs significantly from a standard tree view, however in its design and implementation. It allows data entry into selected fields embedded within the tree. It also allows multiple selection of sub-branches within a branch of the tree. In the exemplary illustration shown in

FIG. 41 for a new incident, only the highest level of classification for the Incident Type 431 is shown. This top level classification appears as a list 413 of the Primary Classification Categories 74 as previously defined for the Incident Type 271 using the hierarchical structure generation and management module 32 and stored in the Database according to this embodiment 2. Each Primary Classification Category 74 is displayed as a text title of the Primary Classification Category 422 with an associated icon 423.

The user begins the classification of a new incident by selecting one of the Primary Classification Categories 422. This is done by clicking on its icon 423. When a Primary Classification Category 422 has been selected, the first level of incident classification questions 481 is opened as shown in FIG. 48. These questions are the first of possibly many levels of classification questions as defined in the Incident Classification system 57 for the Incident Type 431. This appears as a list of questions 481, each attached to a question mark icon 482. When the user clicks on a question, a list of pre-defined responses 483 is displayed. These responses are as defined for the question in the Incident Classification System 57 for the Incident Type 431. Each response appears to the user as a text description 483 attached to an appropriate data entry field 484. The nature and appearance of the data entry field 484 depends on the type of response required. In the design of the Incident Classification System 57, some response fields allow the user to select more than one response by clicking square “checkboxes” 484, some response fields allow the user to select only one response by clicking a round “radio button” 486, and some response fields allow the user to enter text, for example the description associated with response “Other” 485. When the user has selected or entered a response, the next level of the incident classification questions is displayed.

The user continues the incident classification process until the deepest level of the incident classification is reached. A visual indicator on each icon informs the user whether there is a further deeper level of classification. The user then repeats this process for the next question and continues until all the questions for the Primary Classification Category 413 have been answered. The user then repeats this process for the next Primary Classification Category 413 and again for the remaining Primary Classification Categories 413 until all the questions for all Primary Classification Categories 413 have been answered.

By careful design and entry of classification definitions into the Incident Classification Structure 57, the Primary Classification Categories 413 are tailored to each Incident Type 431. Similarly, as the user proceeds to deeper levels of the classification, each level is designed to offer the user an appropriate and comprehensive set of possible questions 481 and possible responses 483 to each question. If none of the offered responses 483 are appropriate for a question 481, the user chooses Other 485 and enters a text description for the response. The Rule 487 associated with each classification question 481 and response 483 in the hierarchical structure generation and management module incident classification is displayed at all times to assist the user.

The user may change, save 488 or cancel 489 responses at any stage. When an incident data entry is complete, the user saves the incident in the database by clicking the Save button 424. The system provides safeguards to ensure that incident records are either complete or classified as incomplete 494, as illustrated in FIG. 49. An incident that contains any missing entries in mandatory data fields 491 is not allowed to be marked as complete. An incident that contains any missing entries in mandatory classification items 493 cannot be marked as complete. If an incident record is not complete it is not included in analysis reports and plots performed using the Analyser module 34. The user may choose not to continue detailed classification below a level, or may choose not to answer a question at all. Any Incident Types 431 and any other items in the incident classification structure may be “targeted for classification” 492 in the Administrator module and therefore require mandatory classification, but beyond the mandatory items 493, the amount of detail supplied for an individual incident is as chosen by the user entering the data. Clients may choose to target particular classification items for research or other purposes. The design of the Incident Classification Structure 57 also includes a periodic review process 25 (refer FIG. 2) which enables refinements to be included periodically, for example by analysis of “Other” 485 responses gathered from incident reports.

Returning to FIG. 35, when the user highlights an Incident row 352 and selects the Open button 355, the Incident Data Entry form appropriate for that incident appears and the previously entered incident data is displayed. The user then has the ability to perform all the actions as described above for the New button 354, as well as to examine the data without making changes. The user is able to view all the data entered on the left side form 411 by scrolling as will be understood by anyone skilled in the art. The user is able to view all the classification data on the right side 412 by scrolling and by clicking the Classification Category icons 423 to expand or collapse branches of the classification as previously entered for the incident. Although the number of possible branches in the classification can be extremely large, the number of branches actually used in any one incident classification is not excessive and may be viewed easily in this way. When the user clicks an icon that is not a top-level Primary Classification Category icon 423, the entire classification structure available at that level is displayed, not just the classification previously entered for the incident. The user may then proceed to enter further details or make changes as necessary. The user may choose to expand either the left side 411 or the right side 412 to occupy the whole computer screen, to assist in viewing or entering the data. The ability of a user to view, add and update data is at all times subject to the security rules previously assigned to the user by an system administrator using the Administrator module 36. All user actions including data changes are fully tracked in a comprehensive audit trail system as described in the Administrator module 36.

In FIG. 35, when the user highlights an incident row 352 and selects the Copy button 356, the actions are the same as for the New button 354, except that the user is not given a choice of input screens and the screen as shown in FIG. 41 initially contains all the data copied from the selected incident row 352. This data includes both the input data on the left side 411 and the classification data on the right side 412. When the user saves the incident in the database by clicking the Save button 424, a new record is created containing the same data as the original record, except for changes made by the user as described above.

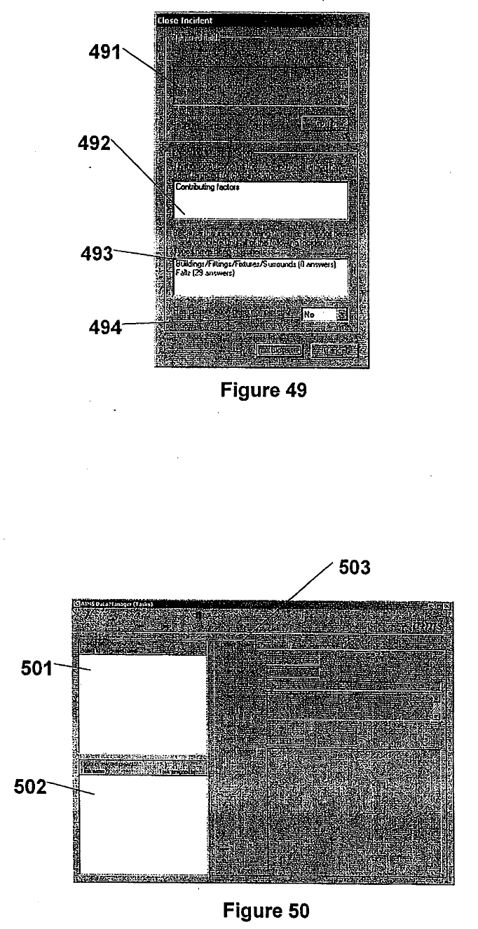

In FIG. 35, when the user selects the Workflow button 361 and selects the “Projects requiring your attention” option, the Data Manager Workflow Tasks screen is displayed as shown in FIG. 50. This shows Projects 501 and Tasks 502 that have been allocated to the user by an authorized user in the Workflow Manager module 35. Details of Tasks, Task Dependencies and the relevant Project may be viewed and edited if appropriate by use of tabs 503 on the right hand side of the screen. The workflow tasks 502 are raised automatically by the system when incidents of nominated types and classification items of nominated types are entered into the Data Manager module. This display is additional to the workflow notifications that are automatically posted to the nominated users by e-mail. The administration of workflows is described further in the description of the Workflow Manager module 35.

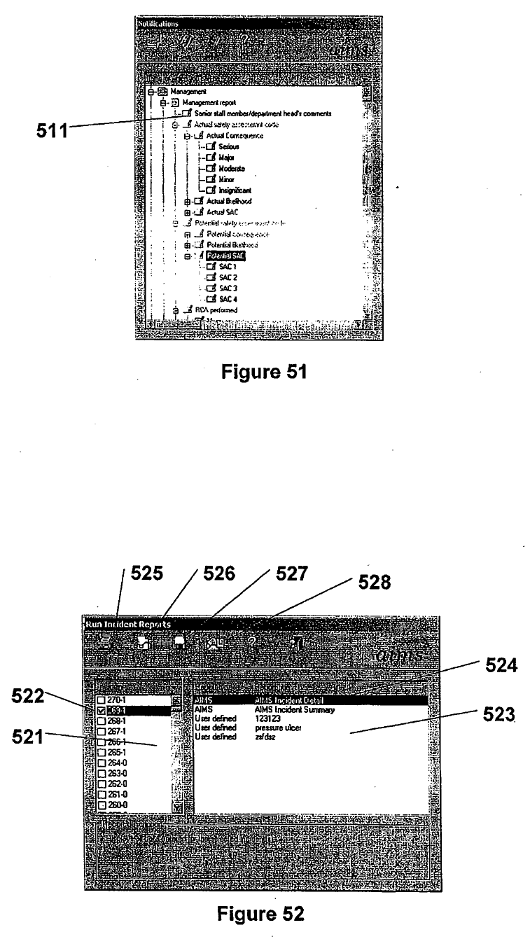

When the user selects the Workflow button 361 and selects the “Notifications” option, the Data Manager Notifications screen is displayed as shown in FIG. 51. This screen shows the data entry items 511 for which notifications will be sent to the user. It also allows authorized users to nominate any data entry items 511 for which they wish to receive notifications. This requires no administrative actions in the Workflow Manager module 35 and is available to clients who choose not to install the Workflow Manager module. The notifications are raised automatically by the system when data entry items 511 of nominated types are entered into the Data Manager module. Notifications appear in Data Manager as shown in FIG. 51 and are also sent to users by e-mail.

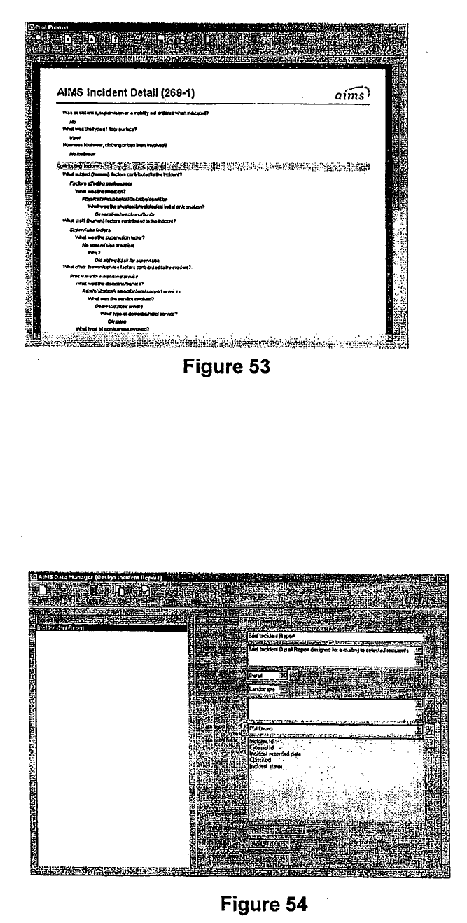

When the user selects the Reports button 362, the Data Manager Reports screen is displayed as shown in FIG. 52. This screen displays the incidents 521 for which the user has authority to view and a list of available Report Types 523. The user selects one or more Incidents 522, selects a Report Type 524 and then clicks one of the buttons Print 525, Preview 526, Export 527 or Send 528. When the user selects the Print button 525, the report is sent to the nominated printer. When the user selects the Preview button 526, the report is displayed on the computer screen. An example of part of an Data Manager detail report is shown in FIG. 53. When the user selects the Export button 527, the report is saved to a nominated computer file in one of a number of industry-standard formats as specified by the user. When the user selects the Send button 528, the report is saved to a nominated computer file in one of a number of industry-standard formats as specified by the user and is then sent to nominated users by e-mail. All users who are authorized to use the Data Manager module may create and save report designs and allocate permissions for their use, for example to make them public or private. They can do this by use of the Data Manager Incident Report Designer screen shown in FIG. 54. The Data Manager Reports are able to contain all incident data, including potentially sensitive data and are therefore accessible only to users authorized to do so by use of the Administrator module 36.

The Data Manager module works in conjunction with the other System 1 modules which all operate on the same database and are accessible to users as specified in the Administrator module. The structure of the Database according to this embodiment 2 is defined and maintained by the hierarchical structure generation and management module 32. The Data Manager 33 functions are accessible only to authorized users as controlled by use of the Administrator module 36. The Data Manager workflow and notification capabilities are those required by users with access to enter and view the raw data including identification data. The comprehensive workflow functions and workflow administration are included in the Workflow Manager module 35. The Data Manager reports are limited to reports on specific data, which includes identified data. Many other reports and plots are available in the Analyser module 34 and these reports are different from the Data Manager reports because they are summaries and plots based on de-identified data, as described in the Analyser module 34 description.

As described earlier, in this embodiment the System 1 is modular in nature, with different modules providing specific features of the system. We describe here the main features of this embodiment of the invention relating to the Analyser module 34; the main purpose of which is to provide the user with a comprehensive range of reports and charts of incident data to assist with analyses of causes of incidents, frequency and preventability of incidents and any other analyses of interest to hospitals and health authorities.

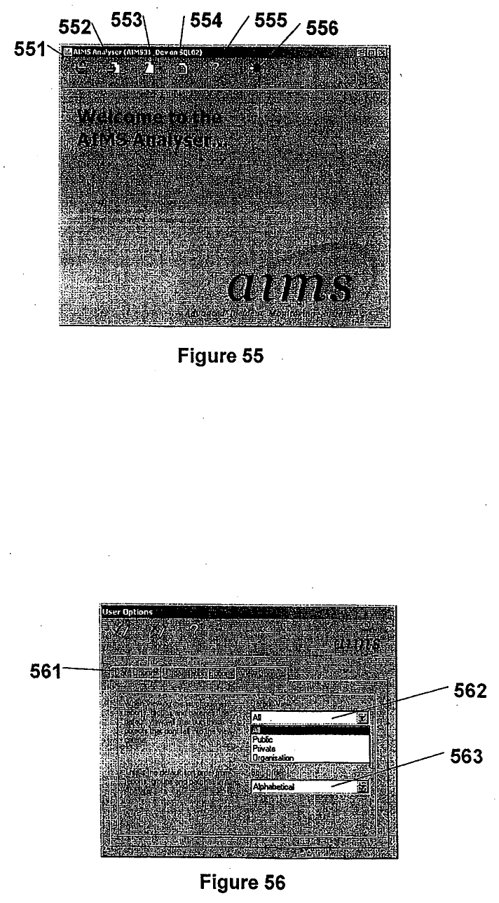

Shown in FIGS. 55 to 69 is a preferred embodiment of the Analyser module 34. This module is shown in the context of the overall System 1 in FIG. 3. A large set of report types and chart types is included in the AIMSs™ System and also the ability for the user to create and store definitions of further report types and chart types. Analyser ensures that only incidents that are both complete and active are included in reports and charts. It also ensures that only incidents at or below the selected Organization 51 (refer FIG. 5) are included. It also ensures that only users with permission to see data, including identified and de-identified data, are able to view or print analysis reports and charts.

Shown in FIG. 55 is the initial screen displayed when the user starts the Analyser module. To proceed, the user must first select the Login button 551 and enter a valid database reference, user name and password. Throughout the Analyser module, security rules previously assigned to the user are applied in order to authorize each user to see and use only appropriate data and actions. For example, a user may be given permission to run reports but not to design reports. These security rules are defined by an system administrator using the Administrator module 36.

Until the user has entered a valid user name and password, only the Login 551, Help 555 and Exit 556 buttons are visible. After the user has entered a valid user name and password, a Run button 552, a Design button 553 and an Options button 554 appear on the screen. When the user selects the Options button 554, an options screen as shown in FIG. 56 is displayed. This screen allows the user to select preferred data viewing options such as preferred date display format 561, filtering 562 and sorting 563 of data on screens, as will be understood by anyone skilled in the art. The Help button 555 and Exit button 556 perform the usual functions common in systems with a window-based user interface, as will be understood by anyone skilled in the art.

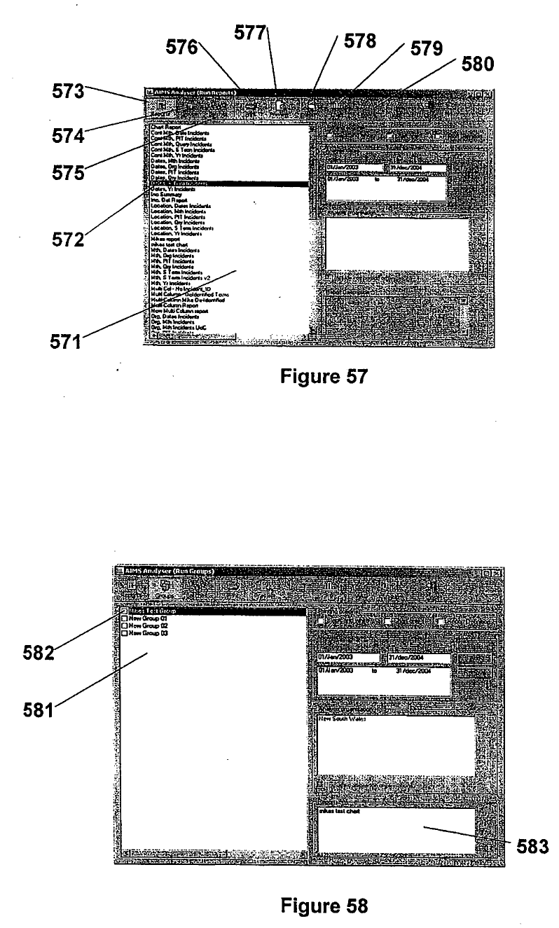

When the user selects the Run button 552, the Run Reports screen as shown in FIG. 57 is displayed. This screen contains a list 571 of all the previously designed Report Designs 572 that the user has been given authority to see. This list contains Report Designs supplied as a standard set of reports and also Report Designs that have been previously designed and stored by an authorized user of the Analyser module. The screen also contains several buttons labelled Reports 573, Groups 574, Batches 575, Print 576, Preview 577, Export 578, Chart 579 and View 580. These buttons allow the user to select further specific actions as described below.

When the user selects the View button 580, the user is given the ability to change previously selected options including but not limited to organization, public/private criteria and sorting.

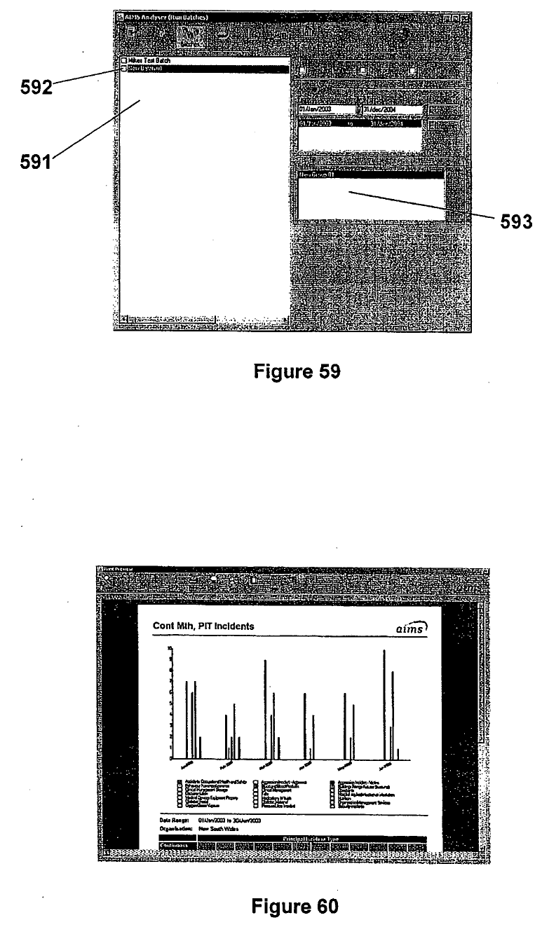

When the user selects the Reports button 573, a list of individual Report Designs 572 is displayed as shown in FIG. 57. When the user selects the Groups button 574, a list of Report Groups 581 is displayed as shown in FIG. 58. When the user clicks on a Report Group 582, a list of Report Designs 583 in that Report Group 582 is displayed. When the user selects the Batches button 575, a list of Batches 591 of Report Groups is displayed as shown in FIG. 59. When the user clicks on a Batch 592, a list of Report Groups 593 in that batch 592 is displayed. The Groups button 574 and Batches button 575 assist the user to rapidly run predefined sets of reports on a selected set of incident data. Reports resulting from the use of the Groups button 574 and Batches button 575 are identical to the individual reports resulting from the use of the Reports button 573.

When the user selects a Report Design 572 and clicks the Print button 576, the selected report is generated from the database and sent to the printer. When the user selects one or more Report Groups 582 or Batches 592 and clicks the Print button 576, all the reports contained in the selected Report Groups 582 or Batches 592 are generated from the database and sent to the printer.

When the user selects a Report Design 572 and clicks the Preview button 577, the selected report is generated from the database and displayed on the screen in the same format as it would appear if printed. An example of a Chart report is shown in FIG. 60. An example of Chart report data is shown in FIG. 61. An example of a Multi-column report is shown in FIG. 62. An example of a Risk Matrix report is shown in FIG. 63.

When the user selects a Report Design 572 and clicks the Export button 578, the selected report is generated from the database and saved to file. The user is given a choice of many industry-standard file formats including but not limited to Portable Document Format (PDF), Rich Text Format (RTF), Excel (XLS), Hypertext Markup Language (HTML) and Extensible Markup Language (XML), as will be understood by anyone skilled in the art. When the user selects one or more Groups 582 or Batches 592 and clicks the Export button 578, all the reports contained in the selected Groups 582 or Batches 592 are generated from the database and saved to file in one of the formats listed above.

When the user selects a Report Design 572 which is of Analysis Type Chart 665 and clicks the Chart button 579, the selected chart is displayed in a form that allows the user a range of options to configure the chart. One example of such a chart display is shown in FIG. 64. Every report of type chart, including user-defined reports, can be displayed in such a format. A number of tabs 641 and parameter entry fields 642 allow the user to tailor a chart's layout and formatting and to view the data contributing to the chart. A major feature of this screen is the ability to “drill down” i.e. the ability to display the detailed data records contributing to the chart. This is achieved by invoking the Data Manager module 33 to display the relevant data records in a display similar to FIG. 35, from with the user may “drill down” further to display any further details that the user has permission to see. The flexible charting functionality is provided by use of a standard chart software module and its functionality is not limited to the example illustrated, as will be understood by anyone skilled in the art.

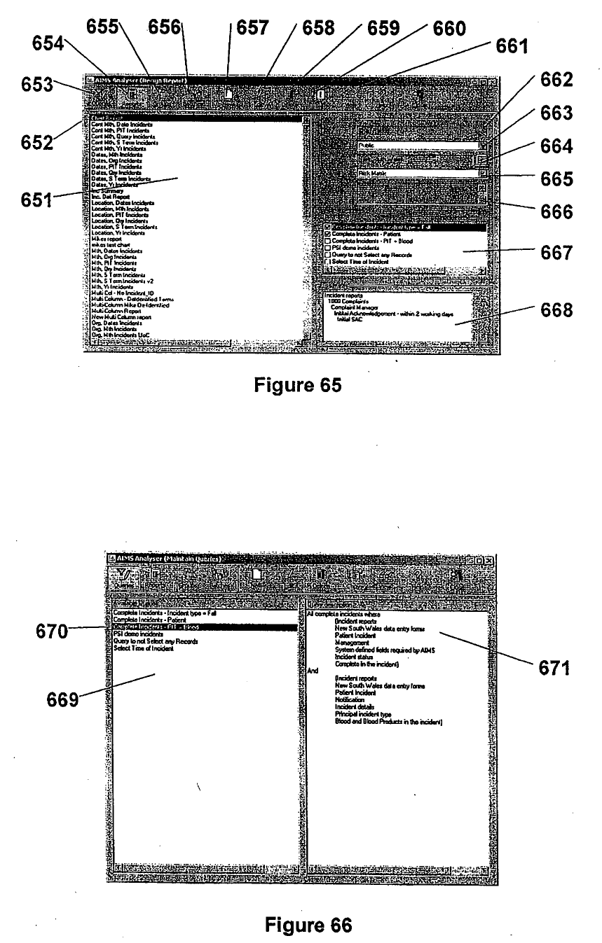

Returning to FIG. 55, when the user selects the Design button 553, the Design Reports main screen as shown in FIG. 65 is displayed. This screen contains a list 651 of all the previously designed Report Designs 652 that the user has been given authority to see. The screen also contains several buttons labelled Queries 653, Reports 654, Groups 655, Batches 656, New 657, Edit 658, Delete 659, Run 660 and View 661. These buttons allow the user to select further specific actions as described below.

In FIG. 65, when the user selects the View button 661, the user is given the ability to change previously selected options including but not limited to organization, public/private criteria and sorting. When the user selects the Run button 660, the Run Reports screen is displayed as shown in FIG. 57. This helps the user to run a report easily while designing reports. When the user selects a Report Design 652 and clicks the Delete button 659, the Report Design 652 is deleted, after the customary confirmation from the user, as will be understood by anyone skilled in the art.

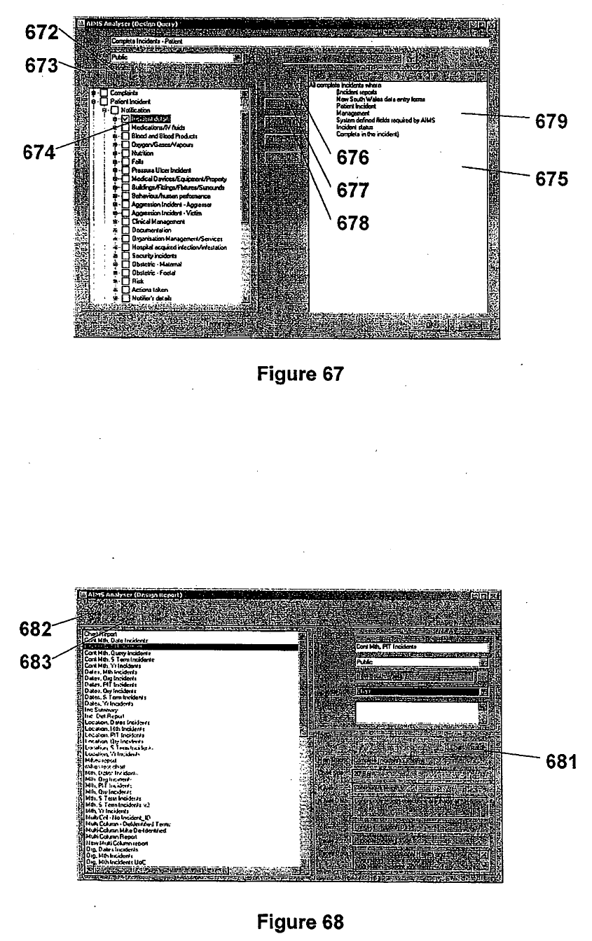

When the user selects the Queries button 653, a list of previously designed Queries 669 is displayed as shown in FIG. 66. When the user then selects a Query 670, the definition 671 of the query is displayed. When the user selects the New button 657, the Query Design Query Builder screen is displayed as shown in FIG. 67. The left side of this screen contains tabs labelled Term 672 and Tree 673. These tabs give the user the choice of using either individual Terms 52 (refer FIG. 5) or explicit Hierarchical Classification Structure entries 54 for inclusion in the query. The lists of Terms 52 and the Hierarchical Classification Structure entries 54 are both as previously defined in the hierarchical structure generation and management module 32. The Hierarchical Classification Structure is displayed in a tree view form and may be navigated, expanded and collapsed, as will be understood by anyone skilled in the art. The user builds a query by selecting an item 674 from the left side and clicking the And button 676, the Or button 677 or the And Not button 678. The right side 675 is initially blank and progressively displays the query definition 676 as the user progressively builds it. Unlike most query builders, which display verbose Structured Query Language (SQL) code statements to the user, this screen displays a relatively compact, high-level definition 679 of what the user has selected to be included in the query. The user therefore does not have to understand the SQL language. The complex SQL statements required to correctly select the required data from the Hierarchical Classification Structure 54 are not displayed to the user.

When the user selects the Queries button 653 and then selects the Edit button 658, the Query Design screen is displayed as shown in FIG. 67. The user is then able to add to the query or make changes as described above for the New button 657.

In FIG. 65, when the user selects the Reports button 654, a list of existing Report Designs 651 is displayed as shown in FIG. 65. The right side of the screen contains report design attributes including but not limited to Title 662, Access 663, Location 664, Analysis Type 665, Description 666 and Report Queries 667. The contents of the right side also depend on the Analysis Type 665 as required, for example to enable entry of additional information required for Risk Matrix 668. These options enable the user to define a large number of Report Designs 651 from a relatively small number of Queries 670.

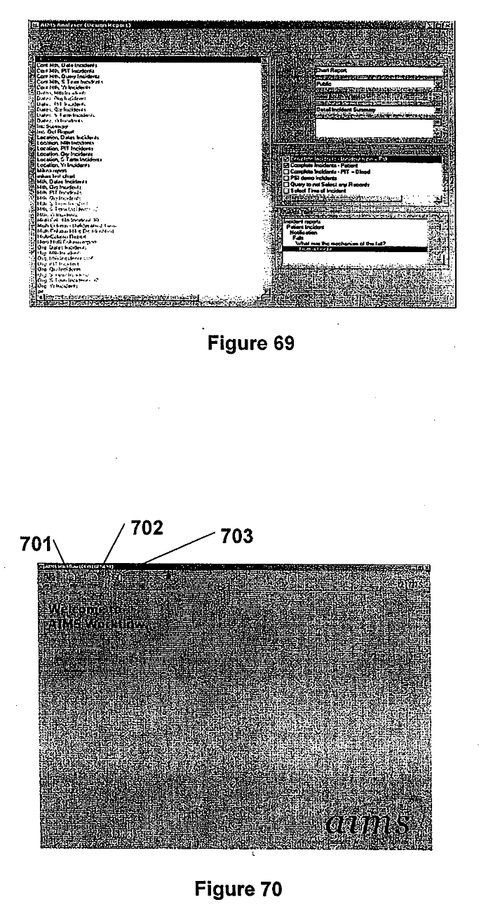

When the user selects the New button 657, the Design Report New/Edit screen is displayed as shown in FIG. 68 if the analysis type is Chart and as shown in FIG. 69 if the analysis type is not chart. When the Analysis Type 665 is Chart, a “Chart Wizard” button 681 is provided to assist the user to make selections of chart type, X axis specifications and Y axis specifications. This button causes a sequence of tailored data entry screens to be displayed, for entry of the X and Y axis specifications, and includes a selection of pre-defined complex groupings of data tailored to the analysis tasks, not just simple analyses by individual data items. The choice of Location 664 is limited to the list of locations as maintained in the Administrator module 36 and defined to be accessible to the user. The choices of Access 663 and Analysis Type 665 are defined by lists from which the user must select. The choice of Queries 667 is as defined by the designer of each Query 669 previously defined and stored in the Database according to this embodiment 2 and whether the access to that query was designated to be public. The user is guided to distinguish count of incidents from counts of answers and to distinguish counts from ratios of counts per Unit of Comparison. Units of Comparison, for example occupied bed days, for each Organization 51 are configured in the Administrator module 36. Buttons Save 682 and Cancel 683 enable the user to save the report design or cancel any changes made since the report design was last saved.

When the user selects the Reports button 654 and then selects the Edit button 658, the Design Report New/Edit screen is displayed as shown in FIGS. 68 and 69 and the items on the right side of the Reports Design screen in FIG. 65 can be modified as described above for the New button 657.

When the user selects the Groups button 655, the left side of the screen contains a list of Report Groups 581 similar to the Run Report Groups screen shown in FIG. 58 with updating buttons New 657, Edit 658 and Delete 659 as in FIG. 65. When the user clicks on a Report Group 582, the list of Report Designs 583 in that Report Group 582 is displayed on the right side of the screen. The Report Group 582 may be modified by clicking the Edit button 658 or deleted by clicking the Delete button 659. A new Report Group 582 may be created by selecting the New button 657.

When the user selects the Report Batches button 656, the left side of the screen contains a list of Batches 592 of Report Groups 581 similar to the Run Report Batches screen shown in FIG. 59 with updating buttons New 657, Edit 658 and Delete 659 as in FIG. 65. When the user clicks on a Batch 592, the list of Groups 593 in that Batch 592 is displayed on the right side of the screen. The Batch 592 may be modified by clicking the Edit button 658 or deleted by clicking the Delete button 659. A new Report Group 592 may be created by selecting the New button 657. Creation of Report Groups 582 and Batches 592 assists the user to rapidly run sets of reports on a selected set of incident data.

Permissions for a user to design Queries and Reports are configured in the Administrator module 36. Permissions for a user to run Reports are configured in the Administrator module 36 and are also controlled by the creator of each Report Design 652.

Most types of analyses require only de-identified data. Users of will only be granted permission to view data when necessary. Specification of data that is private and must be de-identified for analysis purposes is performed in the Administrator module 36. Users who have permission to view identified data may also have permission to create queries and reports using identified data. Administration of which users have permission to view identified or de-identified data is performed in the Administrator module 36.

As described earlier in this embodiment the System 1 is modular in nature, with different modules providing specific features of the system. We describe here the main features of this embodiment of the invention relating to the Workflow Manager module 35; the main purpose of which is to allow the creation, modification and management of workflow projects, activities and tasks associated with incident data entry. The term “workflow” may be commonly understood by those skilled in the art to mean a sequence of planned activities and tasks which may be time dependent and which may be assigned to individuals to complete.

In this embodiment, workflows can be accessed in two main ways; through the Data Manager module, or directly by starting the Workflow Manager module. Access to the Workflow Manager module, its features, functions and data is controlled by the System administrator through the assignment of various access permissions. Users logon to the Workflow manager module using the credentials provided by the System administrator.

The Workflow Manager module 35 is concerned with the creation of sequences of activities and tasks that require completion by individuals. Workflows may be created which are manually initiated by a person, or automatically initiated by the System in response to various triggering criteria.

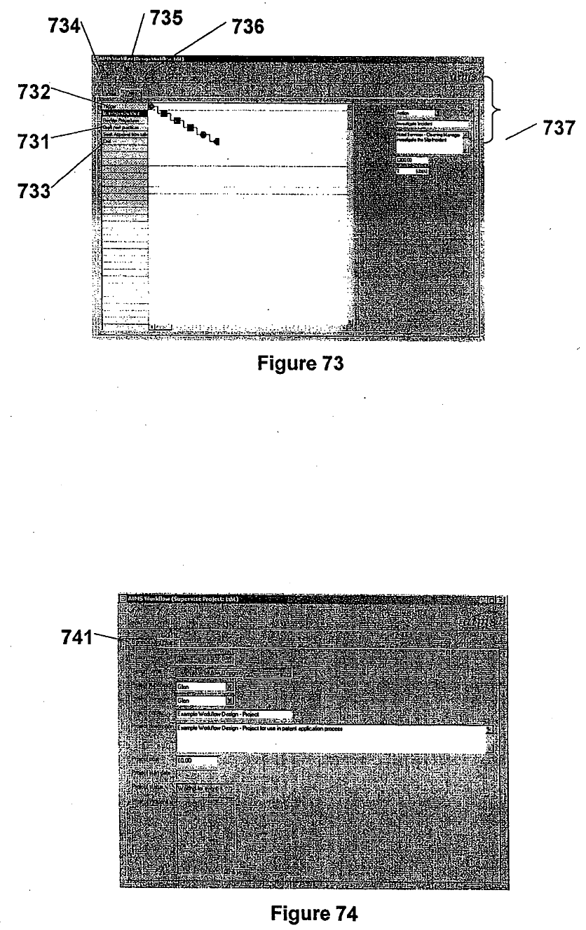

A workflow is a collection of tasks arranged in a logical manner as detailed in the exemplary illustration at FIG. 73. Each activity or “Task” 731 within the workflow is shown as a separate line within the workflow between the start point “Trigger” 732 and the end point “End” 733. Each Task is assigned a “Task Type”, “Task Name”, “Task Description”, “Task Cost” and “Task Duration” as illustrated in the Figure at 734. The collection of workflow tasks is created by building a workflow “Design”.

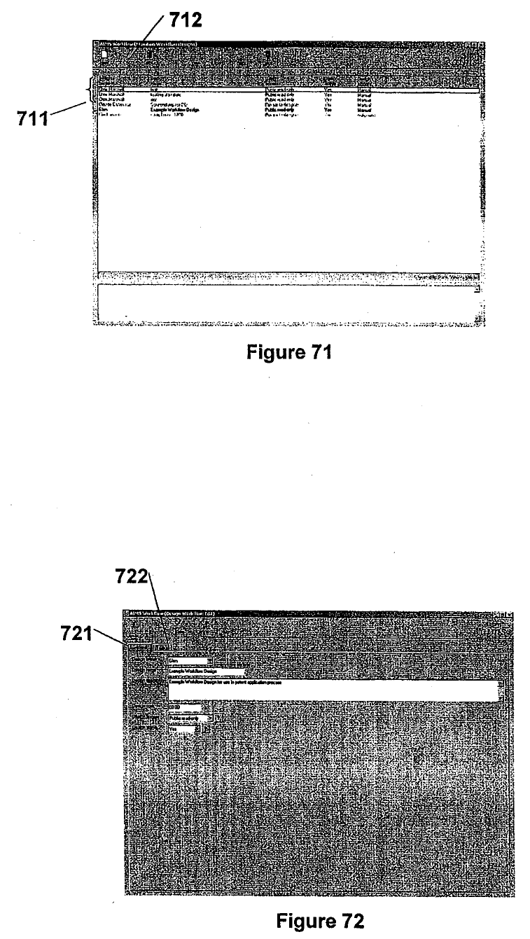

Logging on to the Workflow Manager module displays the “Welcome Screen” illustrated in FIG. 70 with and arrangement of functional buttons along the top “Tasks” 701, “Projects” 702, “Designs” 703. It should be noted that in this exemplary illustration we concentrate our description on those elements of the Workflow Manager module that support the core principles and concepts of the invention, rather than the general features and functions of the system which could be expected to be similarly incorporated into another embodiment by anyone skilled in the art, for example Help and Exit. Clicking the Design button 703 presents the user with a list of current workflow designs as illustrated in FIG. 71 at 711. Selecting a workflow from this list may be achieved by double clicking the particular workflow design, or by highlighting the design and clicking the Edit button 712. Upon selecting a workflow, the workflow design editing screen appears as shown in FIG. 72 and the user is presented with two data entry tabs “General” 721 and “Tasks” 722. The “General” tab 721 contains basic details and attributes of the workflow design; “Design Owner”, “Design Name”, “Design Description” “Design Cost”, “Design Access” and “Design Active”. The “Tasks” tab 722 holds the principal details of the workflow design, as set out in the exemplary illustration at FIG. 73. New tasks are added to the workflow by clicking one of the existing tasks and the Add button 734 to place a task before or after the currently selected item. Entering the details for the task is done on the right hand side of the screen; “Task Type”, “Task Name”, “Task Description”, “Task Cost” and “Task Duration” as illustrated in FIG. 73 at 737, and this completes the task definition. Finally clicking the Save button 736 causes the workflow design to be stored in the Database according to this embodiment 2. Tasks may be removed from the workflow design by highlighting a task and clicking the Remove button 735.

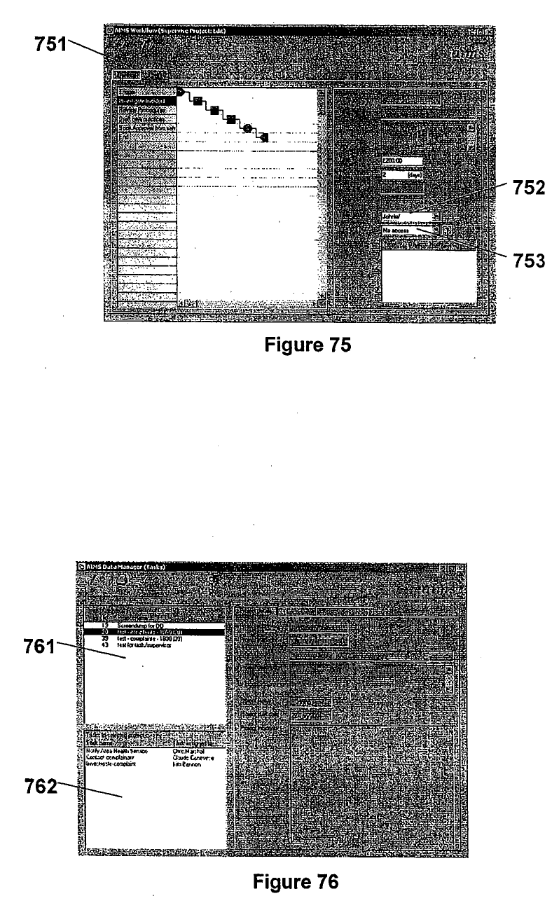

Once a workflow has been designed it may be utilized in a “Project”. A “Project”, in this embodiment of the invention, is an active instance of a workflow design, that may have been triggered automatically by and incident event or manually by a user, and in which the workflow tasks have been assigned to individuals. Projects may be suspended, activated or removed at any time by an authorized project manager. FIG. 74 and FIG. 75 illustrate the definition tabs of a project, “General” 741 and “Tasks” 751 in which it is apparent from FIG. 75 that the “Investigate Incident” task has been assigned to “JohnW” as can be seen at 752. The “Incident Access” choice at 753 enables a project supervisor or manager to allow users access to incidents that originated the project workflow, which in some cases they may not ordinarily have permissions to access because of their security configuration. The aim of this feature is to enable a controlled form of access for the purposes of particular incident investigation. The workflow module additionally provides facilities for task notifications via email, thereby enabling the Project supervisor to create a mechanism to notify an individual that a task is required, to notify a manager if the task is not done within an allotted time, and to escalate to a senior manager if the task remains incomplete after a number of days beyond the task due date. In this embodiment of the invention, Projects are the principal vehicle for allocation of workflow tasks to individuals, however it may be readily contemplated that other embodiments may assign workflow tasks by other means.

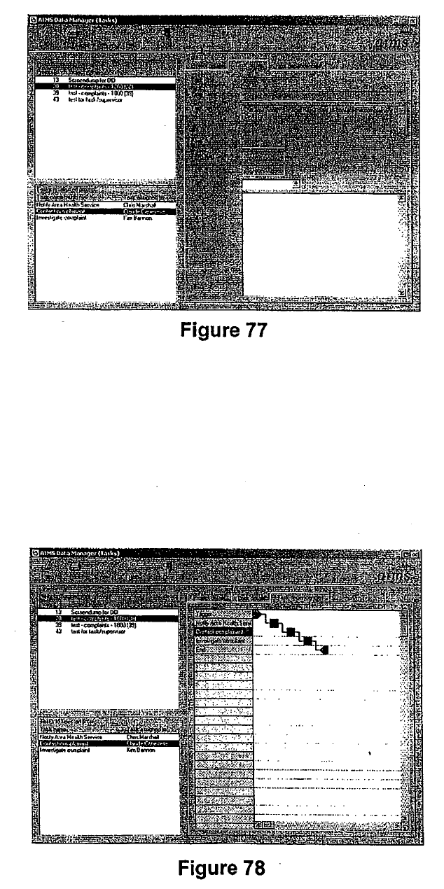

Referring again to FIG. 70, clicking the Tasks button 701 opens the main task window illustrated at FIG. 76. From here a user may see a.) the projects which require their attention 761, b.) discrete tasks which require their attention 762. On the right hand side of the screen a number of tabs are displayed which provide more details about the “Project details”, “Task details” and “Task Dependencies”, as illustrated in FIG. 76, FIG. 77, and FIG. 78 respectively. Users enter details onto the tab pages to update details such as project incidents, task completion, and task comments. Entering a task completion date closes the task and marks it as complete. The screen illustrated in FIG. 76 is the principal screen exposed when accessing the workflows from within the Data Manager module.

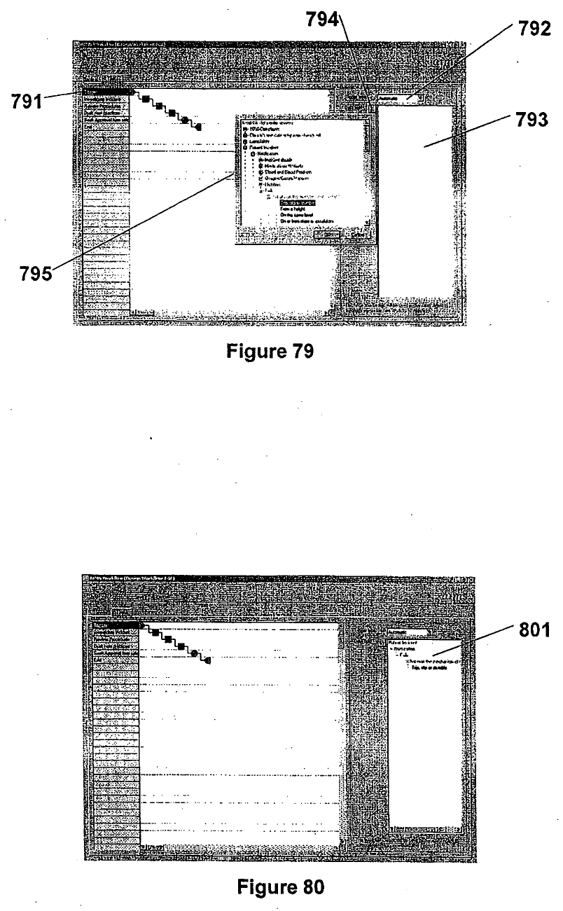

We stated earlier that Workflows may be manually initiated by a project supervisor or automatically triggered by the System in response to an incident entry in the Data Manager module 33. The triggering mechanism is setup in the workflow design screens described earlier. FIG. 79 shows the workflow task creation screen and the “Trigger Type” selection at 792. The Trigger Type selection only appears when the first task in the left hand window is selected at 791. Choosing the “Automatic” option from Trigger Type selection opens the “Data Field” selection window at 793. From here, clicking the “Data field” button 794 opens the available data entry items viewer 795. Navigating through the data entry fields hierarchical display, the user can choose a trigger point from the list, in this exemplary illustration “Trip, slip or stumble” has been selected from the data entry items viewer. Clicking “Ok” places the selected item into the Data Field selection window 793 as illustrated in FIG. 80 at 801. By choosing an automatic trigger and setting the data entry field value in this way, any active projects based upon this workflow design will be triggered whenever a user enters a value on a data entry Form corresponding to the selected trigger Data Field, in this exemplary illustration “Trip, slip or stumble”.

The workflow designs and projects created by this module and described in this embodiment by the exemplary illustrations set out above are stored in the Database according to this embodiment 2. The System utilizes such information stored in the Database according to this embodiment in the general performance of its functions

Although the Workflow module of the System in this embodiment of the invention is a separate module it can be readily contemplated by anyone skilled in the art that the functionality expressed in this module could be incorporated differently in other embodiments.

As described earlier, in this embodiment the System is modular in nature, with different modules providing specific features of the system. We describe here in summary form, the main features of this embodiment of the invention relating to the Administrator module 36; the main purpose of which is to administer various aspects of the system including in this embodiment of the invention; users, user accounts, groups, permissions, organization structures, data identification permissions, classification targeting definitions, audit logging and tracking, projects, notifications, units of measure, application registration keys, and user defined fields maintenance. It should be noted that in this description of the preferred embodiment we concentrate our description on those elements of the Administrator module that support the core principles and concepts of the invention, rather than detailing the more peripheral features and functions of the system, which could be expected to be included in an embodiment by anyone skilled in the art.

FIG. 81 illustrates the top level screen for the Administrator module showing the four principal functions accessed by the buttons: “Security” 811, “Data” 812, “Audit” 813, and “Register” 814.

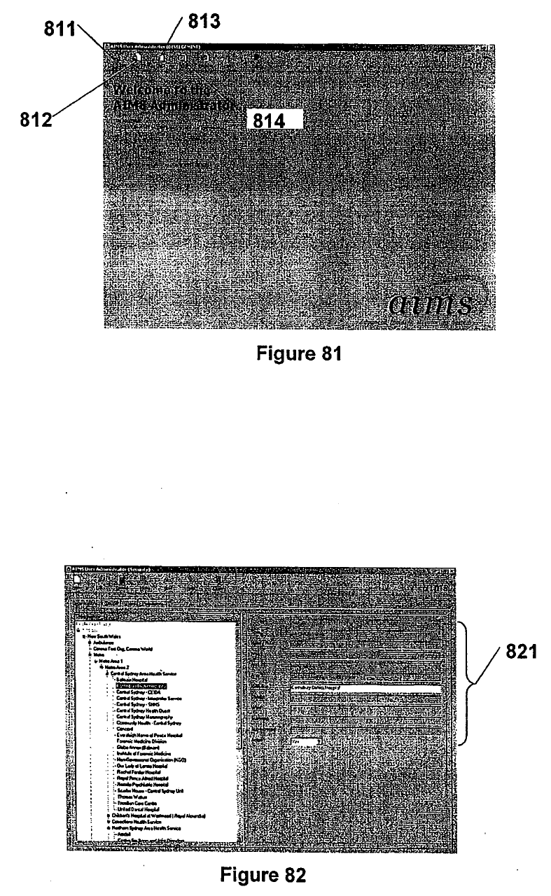

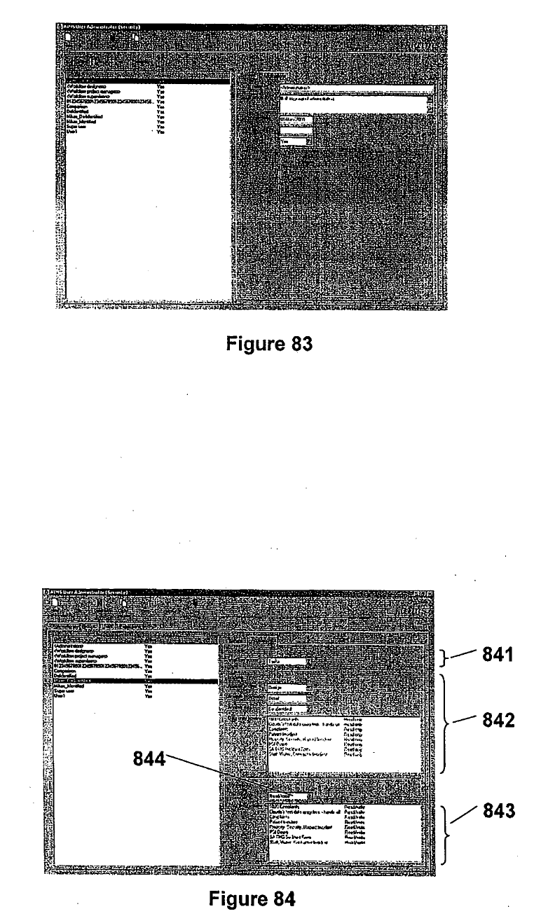

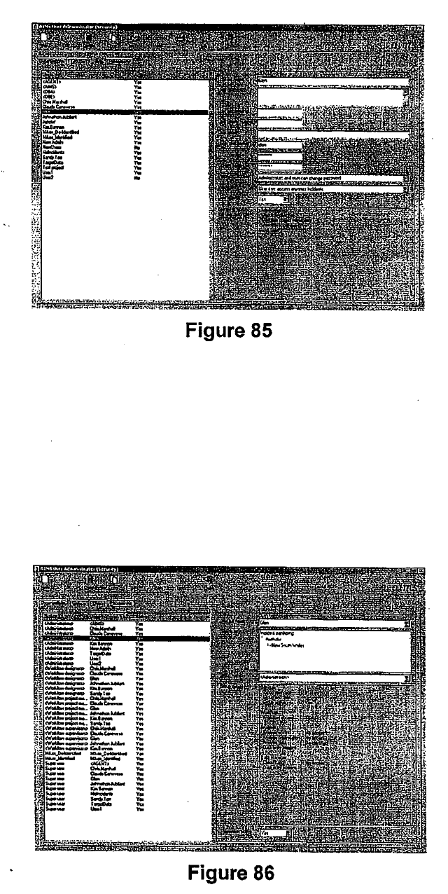

Taking these functions in turn, clicking the Security 811 button opens the security administration screen shown at FIG. 82. As is apparent from the Figure, there are a number of distinct tabs reflecting the different facets of security in the System. The first of these tabs hosts the definition of organizations and their respective sub organization structures at 821. The second tab (itself comprised of two further parts; “General” and “Applications” illustrated in FIG. 83 and FIG. 84 respectively) shows the definition of security groups and group access to modules within the system, the third tab (illustrated in FIG. 85) the individual users within the system, and the fourth tab (illustrated in FIG. 86), the permissions granted to each user.

In this embodiment of the invention, the combination of user, groups and permission definitions is fundamental as it links together the permissions for: a.) Access to modules of the system (as illustrated in the exemplary FIG. 84 at 841, 842, and 843), b.) Levels within the organization structure (as illustrated in FIG. 82 at 821), c.) Access to and usage of data entry Forms visible within the Data Manager module 33 (as illustrated in FIG. 84 at 843) and d.) The capability to classify incidents (as illustrated in FIG. 84 at 844).

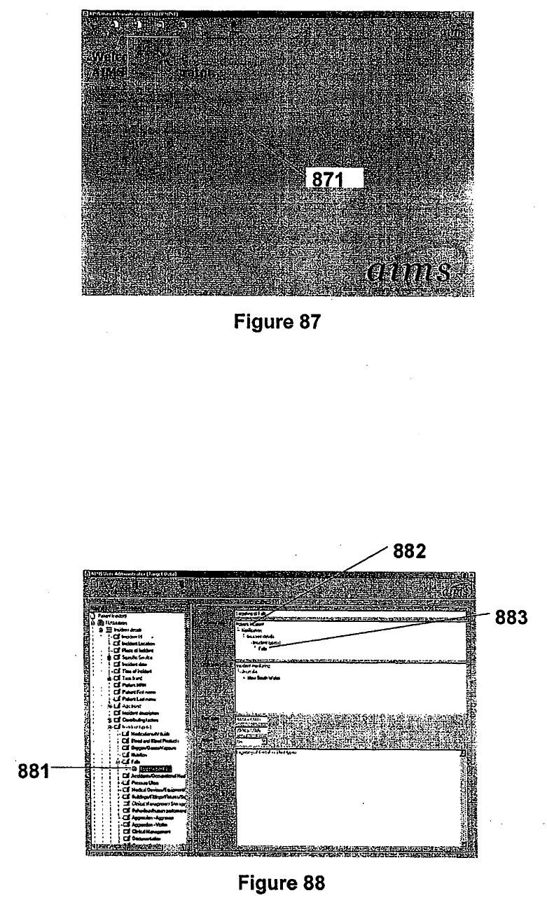

Returning to FIG. 81, clicking the “Data” button 812 allows the administrator to select a number of data-related administration activities as shown in FIG. 87 at 871; “Targeted Data”, “Identified Data”, “User Defined Fields”, “Units of Comparison”, “Notifications”, “Projects”. Of these options, “Targeted Data” is significant since it controls the mandating of incident classification. To explain this further, when an incident is recorded in the Data Manager module 33 it becomes “open” and remains open until the user “completes” the incident record by choosing the option “Yes” when prompted by the system question “Has Classification Been Completed?” If an incident has been targeted, then the incident cannot be marked as complete until the necessary classifications have been done. If the incident requires two or more “HIT” classification hierarchies to be conducted, then it will not be possible to complete the incident unless both “HIT” classifications have been conducted. FIG. 88 illustrates the “Target Data” screen used for identifying which elements of Data Entry Forms will be targeted. In the exemplary illustration the “Targeted Item” 881 is incident type “Falls” at 883, within the “Patient Incident” data entry form 882. In addition, the particular example shows that this is being targeted for the “New South Wales” organization alone.

Returning to FIG. 87, the “Identified Data” option allows the system administrator to enable particular data entry form fields to be either hidden or made visible in the System Analyser module. The purpose of this feature is to provide security for the potentially sensitive content of the System, such as patient name and address details, when performing general incident analyses. In most organizations someone performing general analysis on incidents would have no need to see the detail of the incident.

In FIG. 87, the remaining items; “User Defined Fields”, “Units of Comparison”, “Notifications”, and “Projects” allow the system administrator to create and manage simple user defined fields, create and manage organizational weightings, create and manage notifications and create and manage projects, respectively. We do not set out here a description of user defined fields nor units of comparison as they are not core to the principles of the invention. Elsewhere in this description of the preferred embodiment we have set out the mechanisms by which notifications and projects are created, the administrator module provides set of screens and forms to enable the review and management of such details, so will not be described further here.

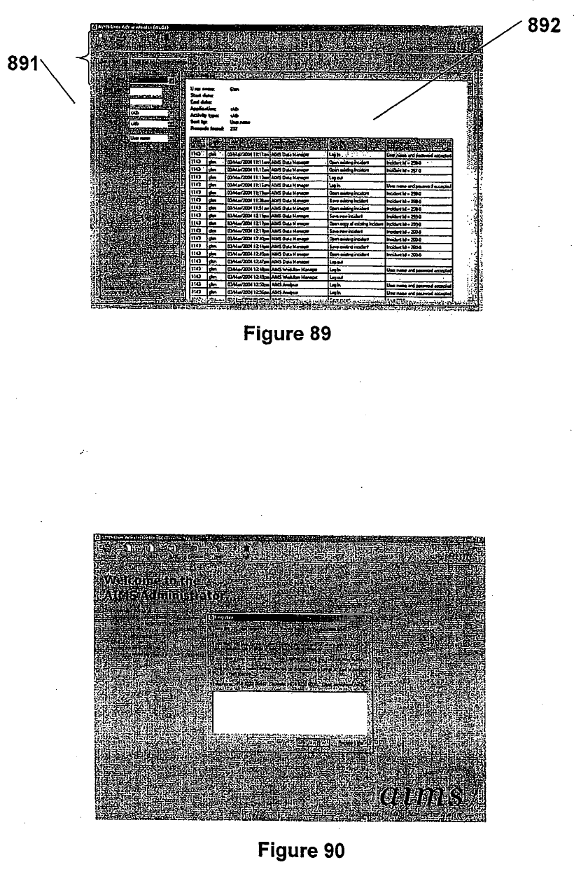

Returning to FIG. 81, clicking the “Audit” button 813 opens the Audit screen as illustrated in FIG. 89. The audit features of the module enable the administrator to follow a comprehensive trail of user activity. As is apparent from the exemplary illustration at FIG. 89, the fields at 891 enable the administrator to produce a report 892 for a range of dates, a particular user, a particular application, an activity type and to sort the resulting report in a variety of ways. The “User Activity” tab shows audit activity for module access and module activity, the “Audit trail log” tab shows changes that have been made to the various items in the Database, and the “Incident history” tabs shows the changes that have occurred to a particular selected incident.

Returning to FIG. 81, clicking the “Register” button 814 displays the System licensing and registration screen at FIG. 90, allowing the administrator to formally register the application.

The administrative details created by this module and described in this embodiment by the exemplary illustrations set out above are stored in the Database according to this embodiment 2. The System 1 utilizes such information stored in the Database according to this embodiment in the general performance of its functions.

Although the Administrator module of the System in this embodiment of the invention is a separate module it can be readily contemplated by anyone skilled in the art that the functionality expressed in this module could be incorporated differently in other embodiments.

As described earlier in this embodiment the System 1 is modular in nature, with different modules providing specific features of the system. We describe here in summary form, the main features of this embodiment of the invention relating to the Database Administrator module 37; the main purpose of which is to provide general Database according to this embodiment utilities including; facilities to control the deployment of enhancements to the Database according to this embodiment 2 and System, facilities for data import and export, and facilities for archiving the Database. Customers use the Database Administrator module to apply system enhancements in their own instance of the System and Database, and to import, export and archive their database contents.

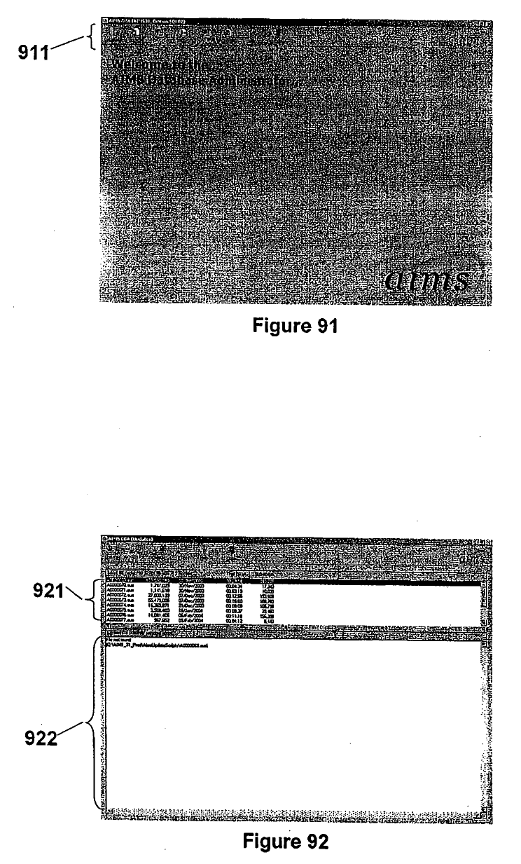

Opening the Database Administrator module 37 displays the screen illustrated at FIG. 91. As is apparent from the exemplary illustration in the Figure, the Database Administrator module has a number of functions that are accessed by the buttons at 911 “Database”, “Updates”, “Export”, “Import”, and “Archive” respectively. Clicking the “Updates” button displays the screen at FIG. 92, which shows the available updates at 921 and the contents of the update scripts at 922. From here users can review the updates already applied to the System, and may choose new updates that they may wish to apply.

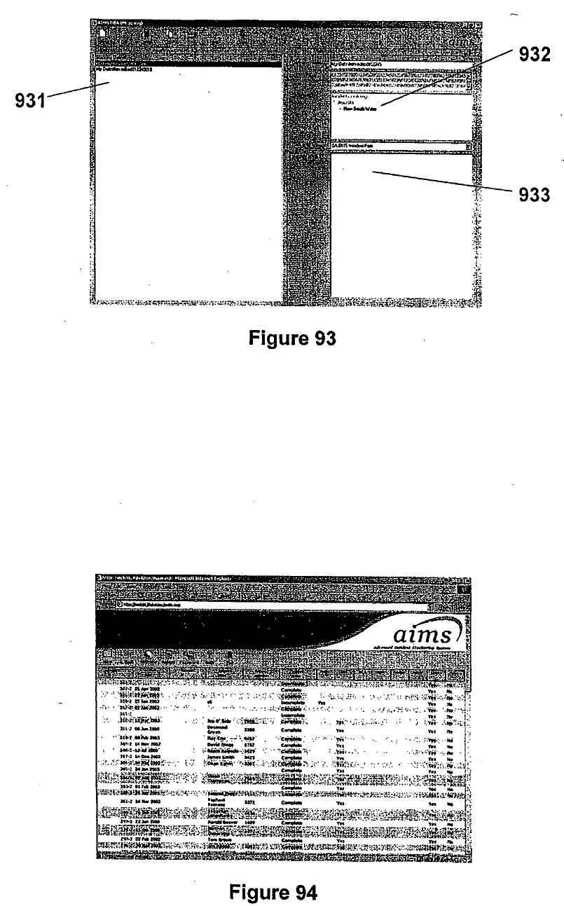

Clicking the “Import” button opens the screen at FIG. 93 which shows the basic features of the import function; defining mappings 931, mapping individual import data fields to Database according to this embodiment items 933, and choosing which organizations will receive the import data, in this exemplary illustration the import will be applied to “New South Wales” 932. The “Export” function operates in a comparable manner. For security/privacy reasons, only de-identified data is exported. These functions are only accessible to administrators of the System.

Although the Database Administrator module of the System in this embodiment of the invention is a separate module it can be readily contemplated by anyone skilled in the art that the functionality expressed in this module could be incorporated differently in other embodiments.

As described earlier in this embodiment the System is modular in nature, with different modules providing specific features of the system. We describe here in summary form, the main features of this embodiment of the invention relating to the Web-Form module 38; the main purpose of which is to provide web based access to the data entry features of the Data Manager module.

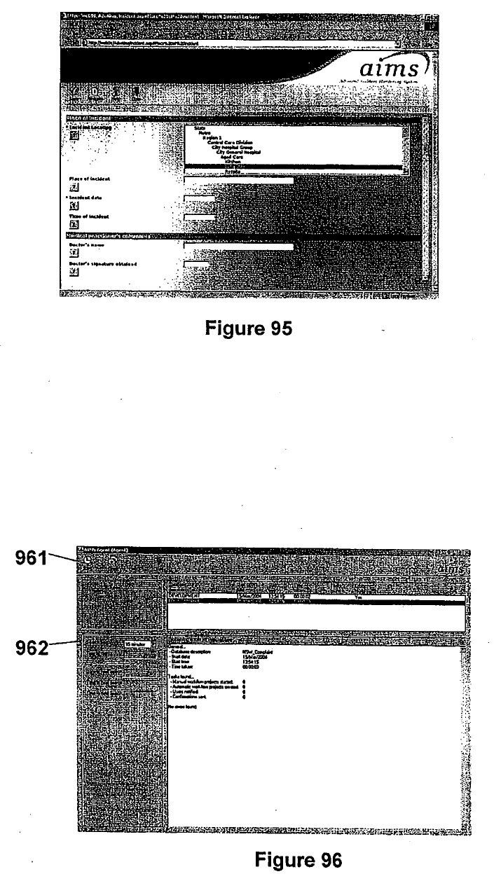

The Web-Form module is illustrated in FIG. 94, which in this exemplary illustration shows an incident. It is apparent that this view is the same view presented to users upon entering the Data Manager module, however in this case, the viewing environment is a web browser (web browser being a generic term, commonly understood by anyone skilled in the art as a graphical interface that lets users view and navigate world wide web content). From this screen, new incidents may be created, existing incidents may be edited , incident reports may be produced and current workflow tasks reviewed, in a manner comparable with the Data Manager module functionality. Clicking an incident from the list shown in this exemplary illustration opens the incident data entry form at FIG. 95 from which incident details may be edited and saved.

Although the Web-Form module 38 of the System in this embodiment of the invention is a separate module it can be readily contemplated by anyone skilled in the art that the functionality expressed in this module could be incorporated differently in other embodiments.

As described earlier in this embodiment the System is modular in nature, with different modules providing specific features of the system. We describe here in summary form, the main features of this embodiment of the invention relating to the Agent module 39; the main purpose of which is to periodically poll the Database according to this embodiment for notification occurrences and workflow trigger events.

The Agent module 38 is illustrated in FIG. 96. In this exemplary embodiment the Agent has a 15 minute search frequency (polling period) 962, which means that it will interrogate the Database according to this embodiment for notification occurrences and workflow triggers every 15 minutes until it is stopped. When interrogating the Database according to this embodiment for notification occurrences the Agent looks for notification definitions that have been created and configured in other modules of the System, such as the Data Manager module, the Workflow module or the Administrator module. Similarly the Agent interrogates the Database according to this embodiment for workflow triggers that have been created in the Workflow module. In the exemplary illustration set out earlier, a workflow trigger was set for the “Trip, slip or stumble” data entry field, the Agent will look for instances of this item in the Database according to this embodiment since its last polling, and for each occurrence will initiate the corresponding workflow. The Agent may be started or stopped at any time by clicking “Start/Stop” button 961.

Although the Agent module of the System in this embodiment of the invention is a separate module it can be readily contemplated by anyone skilled in the art that the functionality expressed in this module could be incorporated differently in other embodiments.

As described earlier in this embodiment the System 1 is modular in nature, with different modules providing specific features of the system. We describe here in summary form, the main features of this embodiment of the invention relating to the Export module 40; the main purpose of which is to provide a means to extract data contained in the Database, for example to combine data from many sources for further analysis.

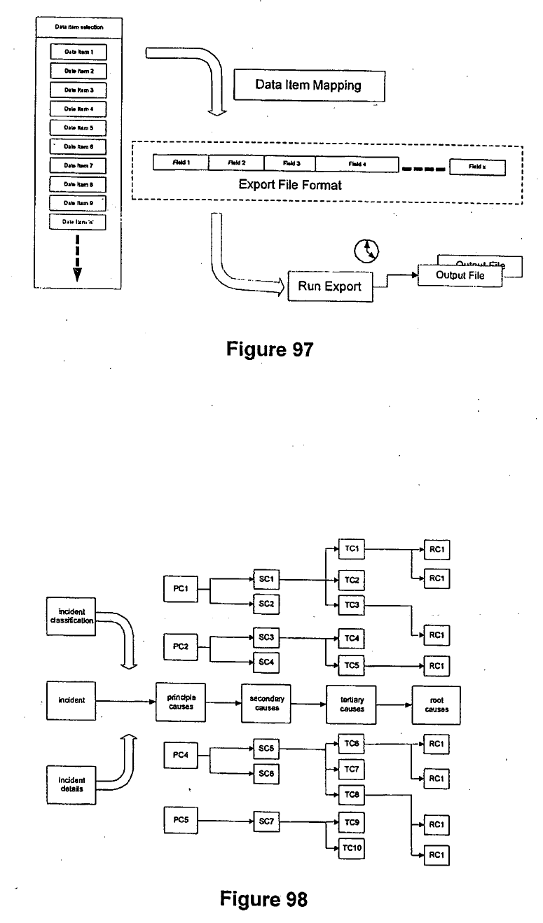

The Export module allows an authorized user of the System to configure an extract of de-identified incident data in a structured manner. The module allows for the specification of data items to export, the positioning of those items in the export file, the selection of the export file format and the execution of the file export which may itself be configured as either a manual or an automatic/timed export action. An audit of exports is maintained by the Administrator module 36, as described earlier. FIG. 97 illustrates the approach.

Although the Export module 40 of the System in this embodiment of the invention is a separate module it can be readily contemplated by anyone skilled in the art that the functionality expressed in this module could be incorporated differently in other embodiments.

As described earlier in this embodiment the System 1 is modular in nature, with different modules providing specific features of the system. We describe here in summary form, the main features of this embodiment of the invention relating to the Root Cause module 41; the main purpose of which is to enable incident root cause analysis. Root Cause Analysis (RCA) is commonly understood by those skilled in the art to mean a technique for identifying the fundamental causes of an incident. There are many recognized methodologies for conducting RCA, however all are predicated upon a thorough classification of the incident in focus. In this embodiment of the invention, the hierarchical classification structure 57 provides a baseline for the RCA activities.

The RCA process is illustrated at FIG. 98. The root cause analysis process is concerned with successive iterations to elicit the causes of a particular incident. The exemplary illustration at FIG. 98 shows a simple four iteration analysis to derive root causes. Information stored in the Database according to this embodiment 2 in the hierarchical structure is used to support the analysis by providing incident classification information and incident detail information, using the Runciman Model 42 illustrated earlier as the basic template. The RCA module utilizes the principles of the Analyser module 34 to produce successively detailed analysis reports indicating the causes at each level of analysis/iteration.

Although the Root Cause module 41 of the System in this embodiment of the invention is a separate module it can be readily contemplated by anyone skilled in the art that the functionality expressed in this module could be incorporated differently in other embodiments.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. A method for assisting analysis of avoidable potentially harmful incident data which includes collecting and classifying incidents, the method including displaying a first of a hierarchical series of response requests in the form of a question to be answered,
selecting for each said first response request one or more generic response identifiers selected from a data base of a plurality of generic response identifiers, then using the one or more selected generic response identifier or identifiers to effect a selection from a data base of a further response request question which will be hierarchical to the first said response and then displaying a selected further response request question which is chosen to be relevant to the or each selected generic response identifier,
and storing information sufficient to identify the hierarchy of response request and response identifier or identifiers.

2. The method of claim 1 wherein there are more than one hierarchical series of response requests related to a single incident.

3. The method of claim 1 wherein a combination of the response requests and the corresponding response identifiers in a single hierarchical series can be said to be a classification structure.

4. The method of claim 1 wherein the response requests are those specified by a hierarchical incident model selected for a specific industry or incident type.

5. The method of claim 1 wherein the incident data to be collected is health care incident data.

6. The method of claim 1 wherein the hierarchical incident model is the Runciman model.

7. A computer system arranged to
display a first of a hierarchical series of response requests, then effect a selection of one or more of a plurality of generic response identifiers from a data base in response to said request,
said selection effecting the display of a selected further response request, relevant to the selected generic response identifier,
then to store information sufficient to identify the hierarchy of response request and response identifier,
and repeating these steps to elicit further information about an incident.

8. The computer system of claim 7 further adapted to display data entry forms and resulting classifications together to facilitate the building of incident reporting and classification structures.

9. The computer system of claim 7 wherein selected cascading branches of a classification structure are reused as required in other classification structures.

10. The computer system of claim 7 wherein each classification structure includes a selected number of primary classification categories.

11. The computer system of claim 7 further adapted to accept centralised control and modification of the classification hierarchy.

12. The computer system of claim 7 wherein the text displayed to enable the selection of a generic response identifier is in a user selectable language.

13. The computer system of claim 7 wherein text displayed to enable a selection of a generic response identifier is a user selectable description standard.

14. The computer system of claim 7 wherein rules are used to provide users with context-sensitive help and correct usage instructions, the rules being entered into the database at the time the hierarchy items are entered.

15. A computer programmed so that it will effect a method for assisting analysis of avoidable potentially harmful incident data which includes collecting and classifying incidents, the method including displaying as a visual output a first of a hierarchically arranged series of response requests in the form of a question to be answered,
the computer then effecting a selection for each said first response request answer of a one or more classifying identifier selected from a data base of a plurality of generic response identifiers, then using the one or more selected generic response identifier or identifiers to effect a selection from a data base of a further question which will be follow the context of to the first said response and
then displaying a selected further response request question which is chosen to be relevant to the or each selected generic response identifier,
and storing information sufficient to identify the hierarchy or series in ranking of a response request and response identifier or identifiers.

16. A computer readable storage medium, the storage medium comprising computer instructions for use in effecting the method of claim 1.
